(19) United States
(12) Patent Application Publication
(10) Pub. No.: US 2018/0275790 A1
(43) Pub. Date: Sep. 27, 2018

(54) INPUT DEVICE, SENSOR, ELECTRIC APPARATUS, AND DETECTION METHOD

(71) Applicant: Sony Corporation, Tokyo (JP)

(72) Inventors: Yoshiteru TAKA, Kanagawa (JP); Takeshi KOIZUMI, Miyagi (JP); Tomoki KAWABATA, Kanagawa (JP); Munetake EBIHARA, Tokyo (JP); Akira FUJISAWA, Tokyo (JP)

(21) Appl. No.: 15/753,783

(22) PCT Filed: Jul. 22, 2016
(86) PCT No.: PCT/JP2016/003425

§ 371 Date: Feb. 20, 2018

(30) Foreign Application Priority Data
Sep. 4, 2015 (JP) 2015-175224

(51) Int. Cl. G06F 3/044; G06F 1/16

(52) U.S. Cl. CPC G06F 3/044; G06F 2200/1631; G06F 2203/04102; G06F 1/1626

(57) ABSTRACT

An input device includes a housing and a capacitive sensor provided in the housing, in which the sensor includes: a flexible conductive layer; two rows of sensing units provided in a manner facing the conductive layer; and a structural body which is provided between the two rows when viewed from a thickness direction of the sensor, and separates the conductive layer from the two rows of the sensing units.

### TECHNICAL FIELD

The present technology relates to an input device, a sensor, an electric apparatus, and a detection method.

### BACKGROUND ART

In recent years, a pressure sensitive sensor capable of electrostatically detecting input operation is widely used for various electric apparatuses such as a mobile personal computer (PC) and a tablet PC. As a pressure sensitive sensor device for an electric apparatus, there is a known technology having a configuration including a capacitive element and capable of detecting an operated position and pressing force of an operating element with respect to an input operation face (for example, refer to Patent Document 1).

### CITATION LIST

### Patent Document

### Patent Document 1:

### Japanese Patent Application Laid-Open No. 2011-170659

### SUMMARY OF THE INVENTION

### Problems to be Solved by the Invention

An object of the present technology is directed to providing an input device, a sensor, an electric apparatus, and a detection method, which are capable of detecting pressing force applied to a housing.

### Solutions to Problems

To solve a problem described above, a first technology provides an input device including a housing and a capacitive sensor provided in the housing, in which the sensor includes: a flexible conductive layer; two rows of sensing units provided in a manner facing the conductive layer; and a structural body which is provided between the two rows when viewed from a thickness direction of the sensor, and separates the conductive layer from the two rows of the sensing units.

A second technology provides a capacitive sensor including: a flexible conductive layer; two rows of sensing units provided in a manner facing the conductive layer; and a structural body which is provided between the two rows when viewed from a thickness direction of the sensor, and separates the conductive layer from the two rows of the sensing units.

A third technology provides an electric apparatus including a housing and a capacitive sensor provided in the housing, in which the sensor includes: a flexible conductive layer; two rows of sensing units provided in a manner facing the conductive layer; and a structural body which is provided between the two rows when viewed from a thickness direction of the sensor, and separates the conductive layer from the two rows of the sensing units.

A fourth technology provides a detection method including: determining whether a capacitance change output from each of sensing units forming a plurality of rows exceeds a threshold; and in a case where the capacitance change exceeds the threshold, determining which one of a region above a sensor and outside of the region is applied with pressing force on the basis of the capacitance change.

### Effects of the Invention

As described above, according to the present technology, pressing force applied to the housing can be detected.

### BRIEF DESCRIPTION OF DRAWINGS

FIG. 1A is a plan view illustrating a state in which pressing force is applied to a sensing area of an electric apparatus. FIG. 1B is a plan view illustrating a state in which pressing force is applied to outside of the sensing area of the electric apparatus.

FIG. 2A is a plan view illustrating an exemplary configuration of a sensor. FIG. 2B is a cross-sectional view taken along a line IIB-IIB of FIG. 2A. FIG. 2C is a cross-sectional view taken along a line IIC-IIC of FIG. 2A.

FIG. 3A is a plan view illustrating exemplary arrangement of sensing units. FIG. 3B is a graph illustrating capacitance changes in the respective sensing units in FIG. 3A.

FIG. 4A is a front view illustrating exemplary external appearance of an electric apparatus according to a first embodiment of the present technology. FIG. 4B is a side view illustrating exemplary external appearance of the electric apparatus according to the first embodiment of the present technology. FIG. 4C is a back view illustrating exemplary external appearance of the electric apparatus according to the first embodiment of the present technology.

FIG. 5 is a block diagram illustrating an exemplary configuration of the electric apparatus according to the first embodiment of the present technology.

FIG. 6A is a plan view illustrating an exemplary configuration of a sensing area. FIG. 6B is a cross-sectional view taken along a line VIB-VIB of FIG. 6A.

FIG. 7A is a plan view illustrating an exemplary sensing surface of a sensor. FIG. 7B is a side view illustrating an exemplary side surface of the sensor.

FIG. 8A is an enlarged plan view of the sensing area of FIG. 6A. FIG. 8B is a cross-sectional view taken along a line VIIIB-VIIIB of FIG. 8A. FIG. 8C is a cross-sectional view taken along a line VIIIC-VIIIC of FIG. 8A.

FIG. 9 is a cross-sectional view illustrating an exemplary configuration of the sensor.

FIG. 10A is a plan view illustrating exemplary configurations of first and second electrodes. FIG. 10B is a table illustrating relations between the first and second electrodes and the sensing units illustrated in FIG. 10A.

FIG. 11 is a plan view illustrating an exemplary configuration of the sensing units illustrated in FIG. 10A.

FIG. 12A is a plan view illustrating exemplary arrangement of the sensing units. FIG. 12B is a graph illustrating capacitance changes in the respective sensing units in FIG. 12A.

FIG. 13 is a flowchart to describe exemplary pressing force detecting operation of a controller IC.

FIG. 14A, FIG. 14B, FIG. 14C, and FIG. 14D are cross-sectional views respectively illustrating exemplary configurations of sensing areas in modified examples of the first embodiment of the present technology.

FIG. 15A, FIG. 15B, and FIG. 15C are cross-sectional views respectively illustrating exemplary configurations of sensing areas in modified examples of the first embodiment of the present technology.

FIG. 16A, FIG. 16B, and FIG. 16C are cross-sectional views respectively illustrating exemplary configurations of sensing areas in modified examples of the first embodiment of the present technology.

FIG. 17 is a cross-sectional view illustrating an exemplary configuration of a sensing area included in an electric apparatus according to a second embodiment of the present technology.

FIG. 18A is a plan view illustrating exemplary arrangement of sensing units. FIG. 18B is a graph illustrating capacitance changes in the respective sensing units in FIG. 18A.

FIG. 19 is a flowchart to describe exemplary pressing force detecting operation of a controller IC.

FIG. 20 is a plan view illustrating an exemplary configuration of an electric apparatus according to a third embodiment of the present technology.

FIG. 21 is a flowchart to describe exemplary pressing force detecting operation of a controller IC.

FIG. 22 is a flowchart to describe exemplary pressing force detecting operation of a controller IC.

### MODE FOR CARRYING OUT THE INVENTION

Embodiments of the present technology will be described in the following order with reference to the drawings. Note that a same or correspondent portion will be denoted by a same reference sign in all of the drawings in the following embodiments.

1 First Embodiment (Exemplary Electric Apparatus)

1.1 Outline

1.2 External Appearance of Electric Apparatus

1.3 Configuration of Electric Apparatus

1.4 Configuration of Sensing Area

1.5 Configuration of Sensor

1.6 Detecting Operation of Sensor

1.7 Pressing Force Detecting Operation

1.8 Effects

1.9 Modified Examples

2 Second Embodiment (Exemplary Electric Apparatus)

2.1 Configuration of Electric Apparatus

2.2 Pressing Force Detecting Operation

2.3 Effects

3. Third Embodiment (Exemplary Electric Apparatus)

3.1 Configuration of Electric Apparatus

3.2 Pressing Force Detecting Operation

3.3 Effects

3.4 Modified Example

### 1 First Embodiment

### 1.1 Outline

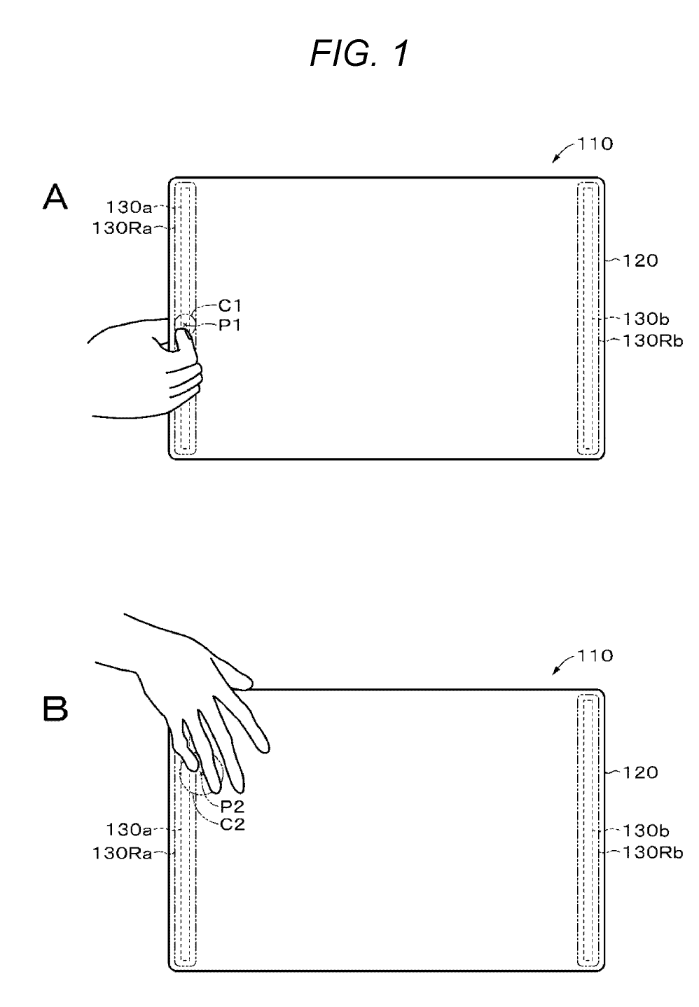

First, an outline of an electric apparatus studied by the inventors of the present technology will be described. As illustrated in FIGS. 1A and 1B, the inventors of the present technology study an electric apparatus 110 having a function to detect pressing force applied to a front surface of a bendable housing 120 (hereinafter referred to as “sensing function”). The electric apparatus 110 includes pressure sensitive sensors 130a and 130b on an inner surface of the housing 120. Sensing areas 130Ra and 130Rb are set in areas (regions) above the sensors 130a and 130b.

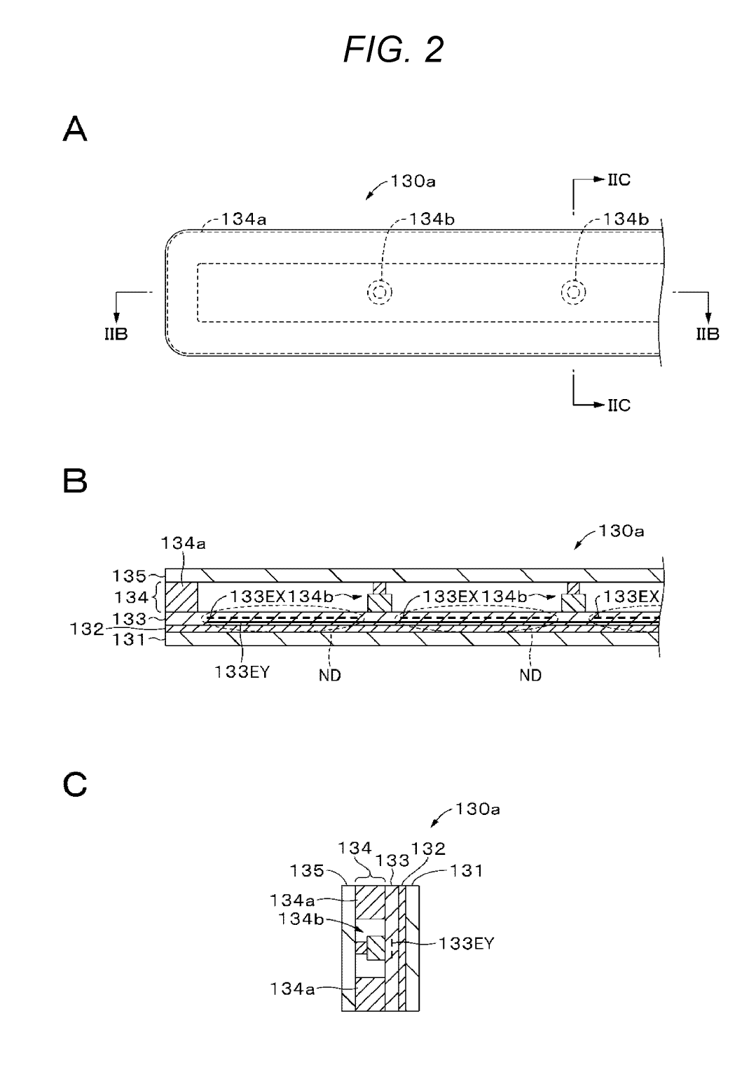

The inventors of the present technology study the use of a following technology as the sensors 130a and 130b. Note that only the sensor 130a will be described because the sensor 130b is similar to the sensor 130a. As illustrated in FIGS. 2A to 2C, the inventors study the use of the following technology, as the sensor 130a, having a configuration including a reference electrode layer (hereinafter referred to as “REF electrode layer”) 131 including a conductive layer, a bond layer 132, a sensor layer 133, a structural layer 134, and a REF electrode layer 135 including a conductive layer The REF electrode layers 131 and 135 are connected to a ground potential.

The structural layer 134 includes: a frame body 134a as a peripheral edge structural body; and a plurality of structural bodies 134b. The frame body 134a and the plurality of structural bodies 134b are provided between the sensor layer 133 and the REF electrode layer 135 and separate the sensor layer 133 from the REF electrode layer 135.

The sensor layer 133 includes a plurality of capacitive sensing units (hereinafter referred to as “nodes”) NDs, and the nodes NDs include first and second electrodes 133EX and 133EY. Note that, in a case of identify each node ND, each node will be described as a node Nn (n is an integer of 1 or more) in the following description.

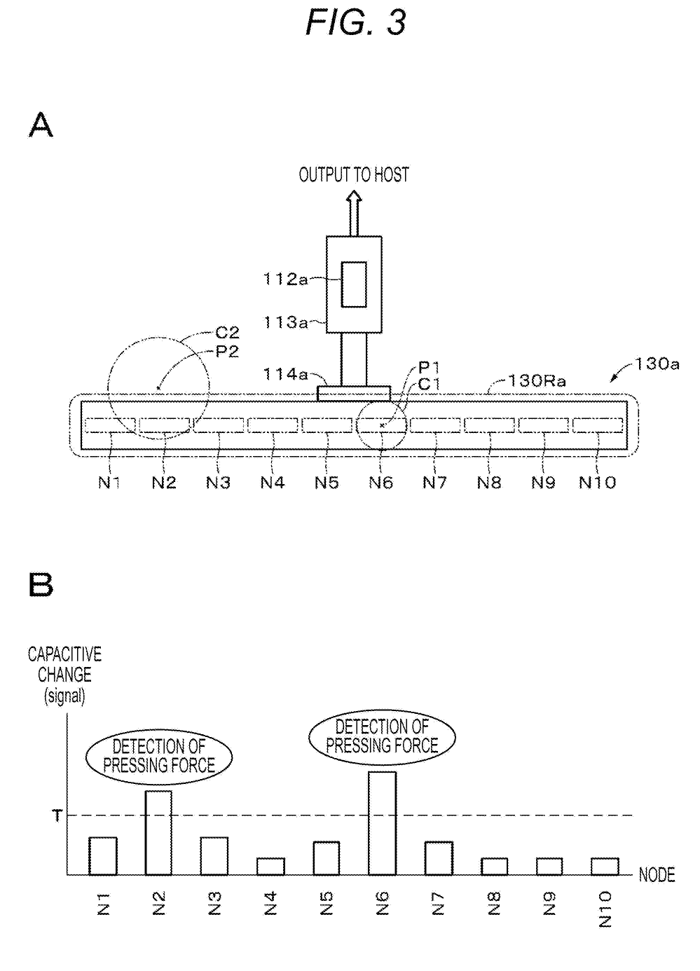

As illustrated in FIG. 3A, the nodes N1, N2, . . . , N9, and N10 are arranged in a line at equal intervals in a longitudinal direction of the sensor 130a. Each of these node nodes N1, N2, . . . , N9, and N10 detects a change of a distance between the sensor layer 133 and the REF electrode layer 135 as a capacitance change (change of voltage signal), and outputs the detected change to a printed circuit board assembly (PCBA) 113a via a flexible printed circuit (FPC) 114a. A controller integrated circuit (IC) 112a mounted on the PCBA 113a determines whether pressing force is applied to the sensing area 130Ra on the basis of a capacitance change supplied from the sensor 130a, and notifies a host (main body) in the electric apparatus of a result thereof. Specifically, for example, in a case where pressing force is detected, a signal (hereinafter referred to as “pressing force detection signal”) to notify the host of detection of the pressing force is turned “ON”.

Meanwhile, considering usability (user friendliness or the like) of the sensing function, preferably, the controller IC 112a detects pressing force applied to the sensing area 130Ra set above the sensor 130a, and notifies the host of a result thereof only in a case where a user intentionally applies pressing force to the sensing area 130Ra.

However, not only in the case where pressing force is applied to the sensing area 130Ra (refer to FIGS. 1A, 3A, and 3B) but also in a case where pressing force is applied to the outside of the sensing area 130Ra (refer to FIGS. 1B, 3A, and 3B), the controller IC 112a may happen to detect pressing force applied to the sensing area 130Ra. Note that, in FIGS. 1A, 1B, and 3A, a position P1 indicates a center position of pressing force (most displaced position) at the time of applying the pressing force to inside of the sensing area 130Ra, and a position P2 indicates a center position of pressing force (most displaced position) at the time of applying the pressing force to the outside of the sensing area 130Ra. Additionally, note that each of areas C1 and C2 illustrated by chain lines schematically indicates an approximate deformed range caused by pressing force. Note that, in the following description, the positions P1 and P2 and the areas C1 and C2 are also intended to indicate similar matters.

The above-described false detection is caused by the following reasons. The controller IC 112a detects pressing force applied to the sensing area 130Ra on the basis of whether a capacitance change supplied from the sensor 130a exceeds a threshold T. Generally, the housing 120 such as the electric apparatus 110 has characteristics of having high rigidity and being bent by pressing force, and therefore, in a case where pressing force is applied to a position distant from the sensing area 130Ra as illustrated in FIGS. 1B and 3A, deformation may also extend to a position of the sensing area 130Ra by being bent depending on how pressing force is applied. In this case, the controller IC receives, from the sensor 130a, a capacitance change exceeding the threshold T, and therefore, false detection that pressing force is applied to the sensing area 130Ra may be caused (refer to the nodes N2 and N6 in FIGS. 3A and 3B).

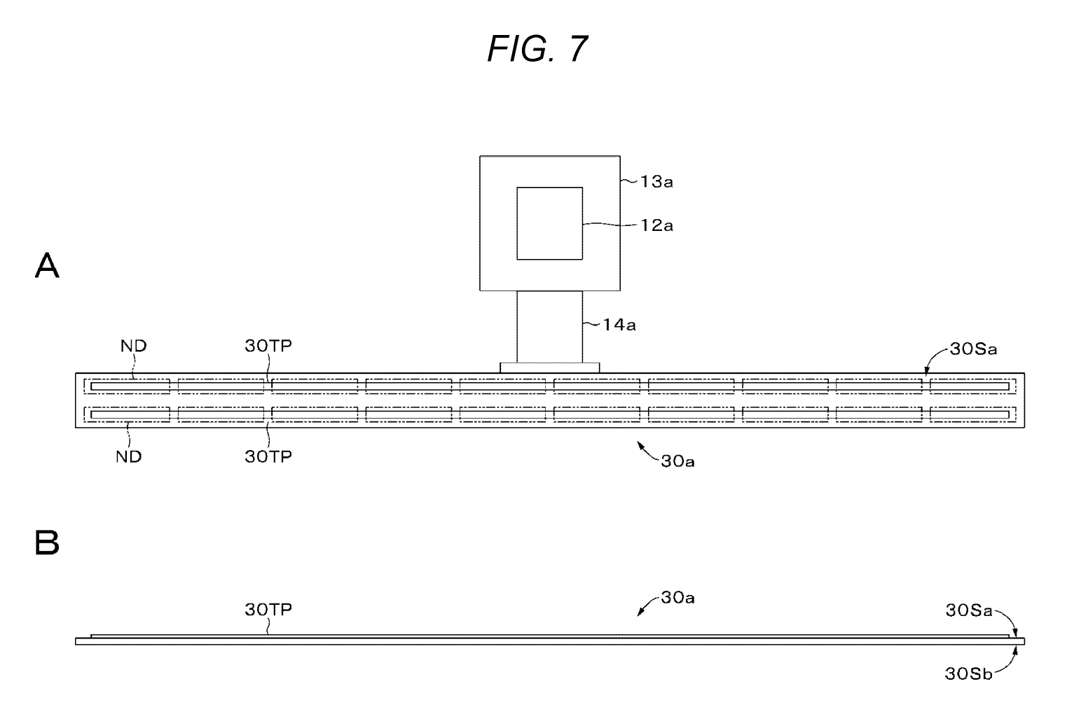

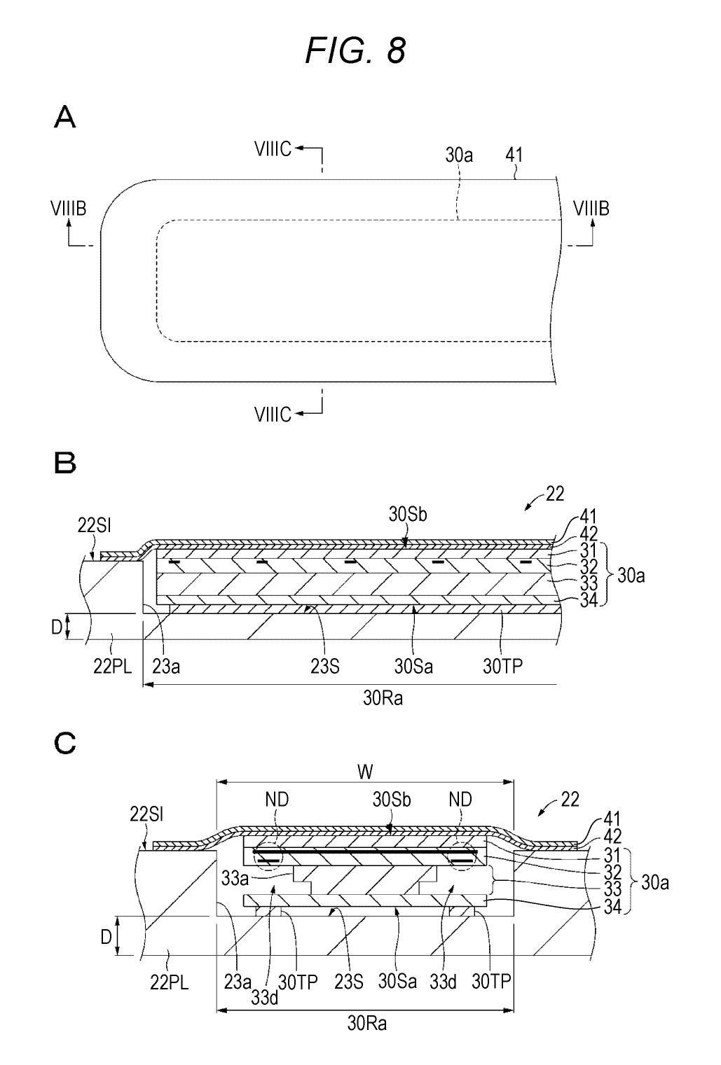

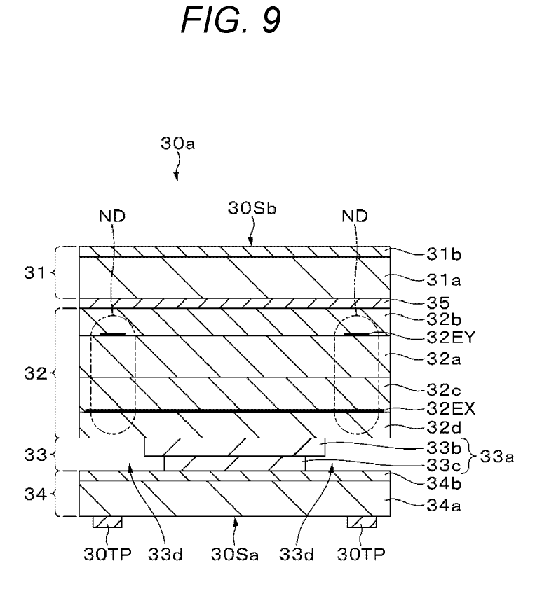

Considering the above situation, the inventors of the present technology has made earnest study on a sensor that can output a capacitance change (specifically, distribution of capacitance changes) by which pressing force applied to a sensing area and pressing force applied to the outside of the sensing area can be determined in order to reduce the above-described false detection. As a result, the inventors have achieved a sensor 30a having a configuration illustrated in FIG. 7, FIGS. 8A to 8C, and FIG. 9. In other words, achieved is the sensor 30a including: a sensor layer 32 including two rows of nodes ND; and a structural body 33a which is provided between the two rows when viewed from a thickness direction of the sensor 30a, and separates the REF electrode layer 34 from the sensor layer 32.

Additionally, the inventors of the present technology has also made earnest study on a detection method to detect pressing force applied to a sensing area on the basis of a capacitance change output from each of the nodes ND constituting the above-described two rows. As a result, achieved is the detection method including: determining whether a capacitance change output from each of the nodes ND constituting the two rows exceeds the threshold; and, in a case where the capacitance change exceeds the threshold, determining pressing force applied to a sensing area and pressing force applied to the outside of the sensing area on the basis of whether a difference between capacitance changes in the two rows exceeds a threshold. Meanwhile, as for the details of this detection method for pressing force applied to the sensing area will be later described in “1.7 Pressing Force Detecting Operation”.

### 1.2 External Appearance of Electric Apparatus

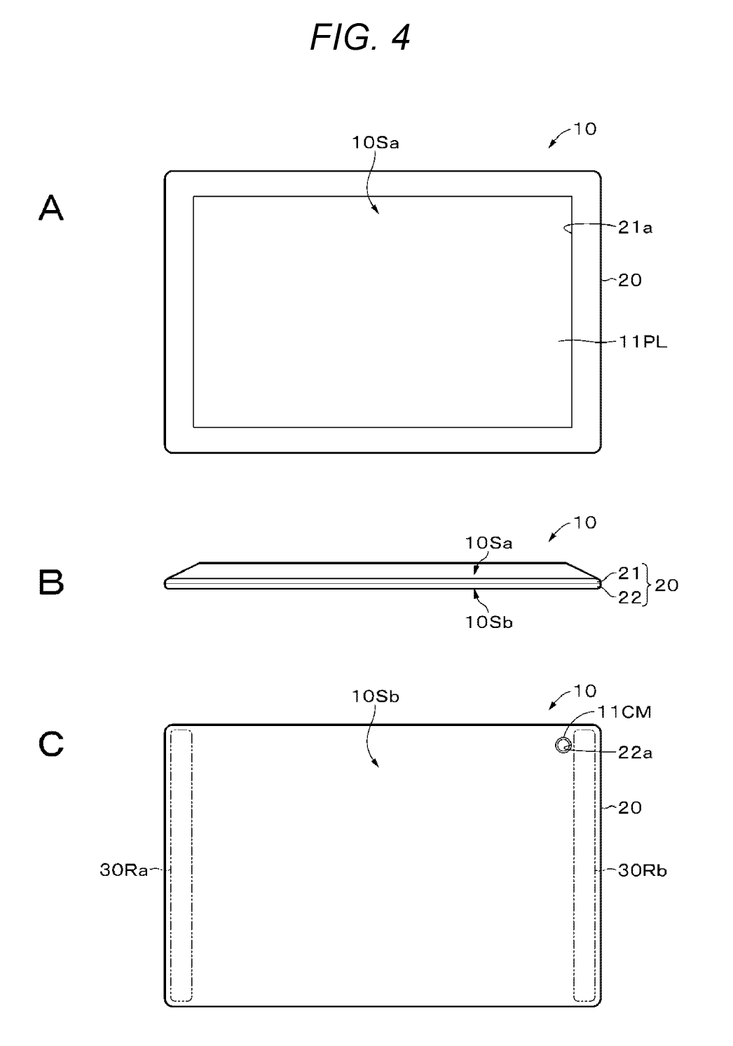

As illustrated in FIGS. 4A to 4C, an electric apparatus 10 according to the first embodiment of the present technology is a so-called tablet computer, has rigidity, and includes a bendable housing 20, and a display device 11PL, a camera module 11CM, and the like are housed in the housing 20. The display device 11PL is provided on a front surface 10Sa side of the electric apparatus 10, and the camera module 11CM is provided on a back surface 10Sb side on the opposite side thereof.

Each of the front surface 10Sa and the back surface 10Sb of the electric apparatus 10 has a rectangular shape having a long side and a short side when these surfaces are viewed from a vertical direction. The sensing areas 30Ra and 30Rb are provided at both end portions in a longitudinal direction of the back surface 10Sb of the electric apparatus 10. The sensing areas 30Ra and 30Rb are provided along peripheral edges of the back surface 10Sb, more specifically, along the short sides of the back surface 10Sb. Each of the sensing areas 30Ra and 30Rb has, for example, a substantially rectangular shape when viewed from a direction vertical to the back surface 10Sb. When a user grips both end portions in the longitudinal direction of the electric apparatus 10, pressing force is applied to the sensing areas 30Ra and 30Rb by a finger and the like, and the electric apparatus 10 executes predetermined operation.

The housing 20 includes, for example, a metal, wood, a polymer resin, or the like. Examples of the metal include elementary substances such as aluminum, titanium, zinc, nickel, magnesium, copper, and iron, or alloys containing two or more of these metals. Specific examples of the alloy can include stainless used steel (SUS), aluminum alloy, magnesium alloy, titanium alloy, and the like.

The housing 20 includes: a first housing 21 constituting the front surface 10Sa side of the electric apparatus; and a second housing 22 constituting the back surface 10Sb side of the electric apparatus. The first housing 21 has a large opened portion 21a extending from a center of the first housing 21 to the vicinity of the peripheral edge portion, and a display portion of the display device 11PL is exposed from the opened portion 21a. A touch panel is provided on the display device 11PL. The second housing 22 has a small opened portion 22a in the vicinity of a corner portion, and a lens portion of the camera module 11CM is exposed from the opened portion 22a.

Examples of the display device 11PL can include a liquid crystal display, an electro luminescence (EL) display, and the like, but not limited thereto. Examples of the touch panel can include a capacitive touch panel and the like, but not limited thereto.

### 1.3 Configuration of Electric Apparatus

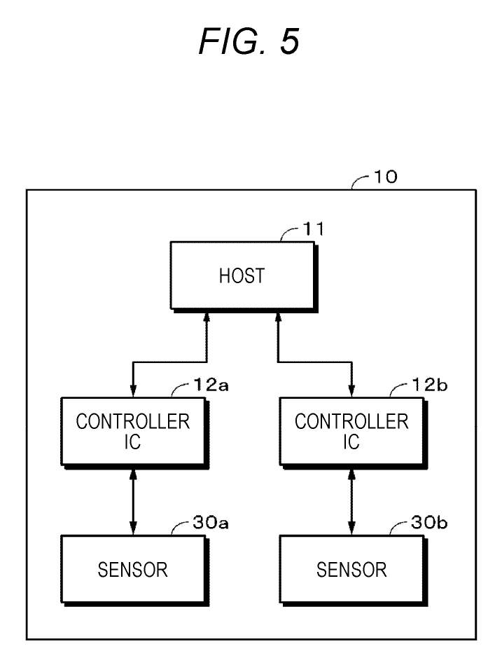

As illustrated in FIG. 5, the electric apparatus 10 according to the first embodiment of the present technology includes a host 11 that is a main body of the electric apparatus 10, sensors 30a and 30b, and controller ICs 12a and 12b as control units. In the present technology, the housing 20 and the sensors 30a, 30b constitute an input device, and the input device may further include the controller ICs 12a, 12b and the like.

The sensors 30a and 30b are so-called capacitive pressure sensitive sensors. The sensors 30a and 30b supply, as capacitance changes, the controller ICs 12a and 12b with pressing force applied to the sensing areas 30Ra and 30Rb.

The controller ICs 12a and 12b detect pressing force applied to the sensing areas 30Ra and 30Rb respectively on the basis of the capacitance changes supplied from the sensors 30a and 30b (more specifically, distribution of capacitance changes), and notify the host 11 of detection results thereof. Specifically, in a case where pressing force is detected, a pressing force detection signal to be output to the host 11 is turned “ON”, and in a case where pressing force is not detected, a pressing force detection signal to be output to the host 11 is turned “OFF”.

The host 11 includes the above-described display device 11PL, camera module 11CM, and the like, and executes various processing in accordance with operation at the touch panel provided on the display device 11PL. For example, the host 11 executes processing such as displaying an image and character information on the display device 11PL, moving a cursor displayed on the display device 11PL, and the like. Additionally, the host 11 executes photographing of a still image or a moving image with the camera module 11CM.

The host 11 controls operation of the electric apparatus 10 on the basis of detection results of pressing force notified from the controller ICs 12a and 12b. For example, in a case where detection of the pressing force is notified, a sleep mode (energy saving mode) of the electric apparatus 10 is canceled. On the other hand, in a case where detection of pressing force is not notified, the sleep mode of the electric apparatus 10 is maintained.

### 1.4 Configurations of Sensing Area

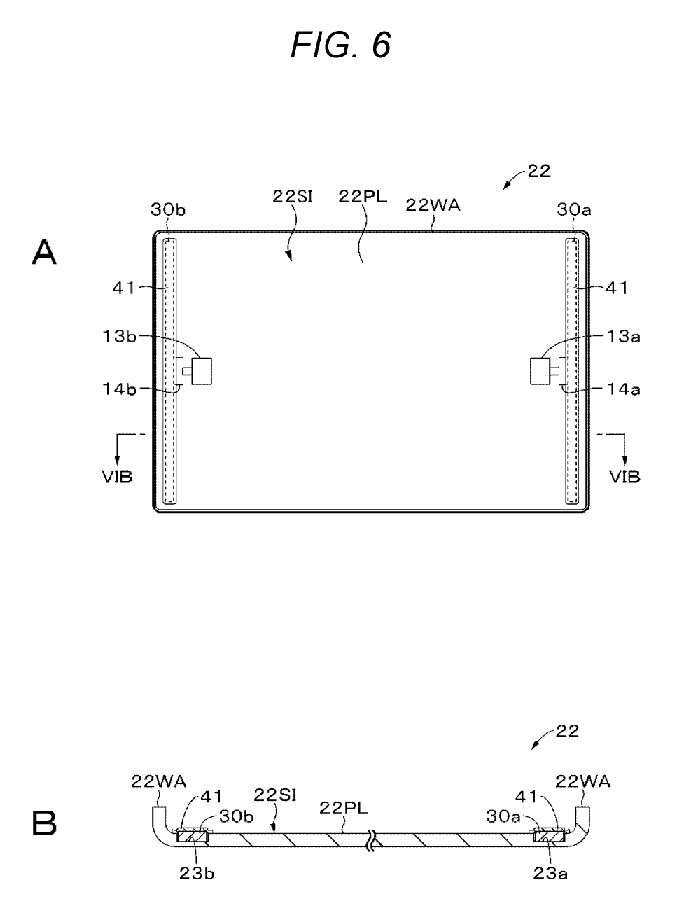

As illustrated in FIGS. 6A and 6B, the second housing 22 constituting the back surface 10Sb side of the electric apparatus 10 includes a plate-like main surface portion 22PL and a peripheral wall portion 22WA provided at a peripheral edge thereof. An inner surface 22SI of the second housing 22 has a rectangular shape having a long side and a short side when viewed from a direction vertical to the inner surface 22SI.

The second housing 22 has recessed portions 23a and 23b respectively at positions on back sides of the sensing areas 30Ra and 30Rb. The recessed portions 23a and 23b are provided respectively at both end portions in a longitudinal direction of the inner surface 22SI. Each of the recessed portions 23a and 23b extends in a short direction of the inner surface 22SI, namely, along the short sides of the inner side surface 22SI. Each of the recessed portions 23a and 23b has a flat bottom surface.

The sensor 30a is housed in the recessed portion 23a, and the housed sensor 30a is held inside the recessed portion 23a by a fixation plate 41 functioning as a fixing member. Similarly, the sensor 30b is housed in the recessed portion 23b, and the housed sensor 30b is held inside the recessed portion 23b by the fixation plate 41.

Preferably, a thickness D of the second housing 22 in each of the bottom surfaces of the recessed portions 23a and 23b (refer to FIGS. 8B and 8C) is thin from the viewpoint of improving detection sensitivity of the sensing areas 30Ra and 30Rb. A ratio (W/D) of a width W in each of the recessed portions 23a and 23b to the thickness D of the second housing 22 in the bottom surface in each of the recessed portions 23a and 23b is, preferably, 20 or more, more preferably, 23 or more. In a case where the ratio (W/D) is 20 or more, detection sensitivity in each of the sensing areas 30Ra and 30Rb can be improved.

The sensors 30a and 30b are electrically connected to PCBAs 13a and 13b via FPCs 14a and 14b, respectively. The above-described controller ICs 12a and 12b are mounted on the PCBAs 13a and 13b.

(Sensor)

Since the sensing areas 30Ra and 30Rb have similar configurations, only the sensing area 30Ra will be described below. As illustrated in FIGS. 7A and 7B, the sensor 30a is a long sheet having a sensing surface (first surface) 30Sa and a back surface (second surface) 30Sb, and can electrostatically detect pressing force (input operation) applied to the sensing surface 30Sa. The sensor 30a has a long thin rectangular shape when viewed from a direction vertical to the sensing surface 30Sa. The sensing surface 30Sa is provided with two projecting portions (first and second projecting portions) 30TP and 30TP extending in a longitudinal direction of the sensor 30a and apart from each other at a predetermined interval. The projecting portions 30TP and 30TP may continuously extend in the longitudinal direction of the sensor 30a or may discontinuously extend in the longitudinal direction of the sensor 30a. Additionally, each of the projecting portions 30TP and 30TP may include a plurality of structural bodies arranged in the longitudinal direction of the sensor 30a.

As illustrated in FIGS. 8A to 8C, the sensor 30a is housed in the recessed portion 23a such that the sensing surface 30Sa and the bottom surface 23S of the recessed portion 23a face each other. The sensing surface 30Sa contacts the bottom surface 23S of the recessed portion 23a via the projecting portions 30TP.

The sensor 30a has a plurality of nodes ND. Each node ND is a capacitive element of a mutual capacitance system. The plurality of nodes ND is arranged in a manner forming two rows in the longitudinal direction of the sensor 30a. Intervals between the nodes ND in the longitudinal direction of the sensor 30a are normally equal. However, depending on characteristics required in the sensor 30a, the intervals between the nodes ND may not be equal. Preferably, each projecting portion 30TP is provided in a manner overlapping with each node ND when viewed in the thickness direction of the sensor 30a. The reason is that detection sensitivity of the sensing area 30Ra can be improved.

(Fixation Plate)

As illustrated in FIGS. 8A to 8C, the fixation plate 41 is fixed to a peripheral edge portion of the recessed portion 23a via a bond layer 42 provided on one surface of the fixation plate 41. Preferably, the fixation plate 41 is fixed such that that the sensor 30a is pressed against the inner surface 22SI of the second housing 22, more specifically, the bottom surface 23S of the recessed portion 23a. The reason is that detection sensitivity of the sensing area 30Ra can be improved. Meanwhile, FIGS. 8A to 8C illustrate an example in which the respective sensors 30a and 30b are supported by one fixation plate 41, but the sensor 30a may be supported by the plurality of fixation plates 41. Additionally, the fixation plate 41 may be fixed to the peripheral edge portion of the recessed portion 23a by a plurality of screw members instead of the bond layer 42 or together with the bond layer 42.

The fixation plate 41 includes, for example, a polymer resin or a metal. The fixation plate 41 may have a layered structure including a polymer resin layer and a metal layer.

### 1.5 Configuration of Sensor

As illustrated in FIGS. 8B, 8C, and 9, the sensor 30a includes a REF electrode layer 31, the sensor layer 32, a structural layer 33, and the REF electrode layer 34. In the following, note that a main surface located on the sensing surface 30Sa side may be referred to as a front surface and a main surface located on the back surface 30Sb side may be referred to as a back surface in a manner similar thereto out of both main surfaces in each of the constituent elements (constituent members) of the sensor 30a.

The REF electrode layer 31 is provided on the back surface 30Sb side of the sensor layer 32 and the REF electrode layer 34 is provided on the sensing surface 30Sa side of the sensor layer 32. Since the REF electrode layers 31 and 34 are thus provided on both surface sides of the sensor layer 32, external noise (external electric field) is suppressed from entering the inside of the sensor 30a. The REF electrode layer 31 and the sensor layer 32 are bonded to each other via a bond layer 35 interposed therebetween. The structural layer 33 is provided between a front surface of the sensor layer 32 and a back surface of the REF electrode layer 34.

(REF Electrode Layer)

The REF electrode layer 31 constitutes the back surface 30Sb of the sensor 30a. The REF electrode layer 34 constitutes the sensing surface 30Sa of the sensor 30a. The REF electrode layers 31 and 34 are connected to the ground potential. The REF electrode layer 31 is a conductive base material having rigidity or flexibility, and includes a base material 31a and a conductive layer 31b provided on a back surface of the base material 31a as illustrated in FIG. 9. The REF electrode layer 31 is provided in a manner such that the base material 31a side thereof faces the back surface of the sensor layer 32. The REF electrode layer 31 has bending rigidity higher than, for example, the sensor layer 32 and the REF electrode layer 34 do, and may function as a fixation plate of the sensor 30a. On the other hand, the REF electrode layer 34 is a flexible conductive base material and includes a base material 34a and a conductive layer 34b provided on a back surface of the base material 34a as illustrated in FIG. 9. The REF electrode layer 34 can be deformed in accordance with pressing force applied to the sensing surface 30Sa of the sensor 30a. The REF electrode layer 34 is provided in a manner such that the conductive layer 34b side thereof faces the front surface of the sensor layer 32.

Each of the base materials 31a and 34a has a film-like or plate-like shape, for example. Here, the film also includes a sheet. As a material of the base materials 31a and 34a, a polymer resin or glass can be used, for example.

Examples of the polymer resin can include, for example, polyethylene terephthalate (PET), polyethylene naphthalate (PEN), polycarbonate (PC), an acrylic resin (PMMA), polyimide (PI), triacetyl cellulose (TAC), polyester, polyamide (PA), aramid, polyethylene (PE), polyacrylate, polyether sulfone, polysulfone, polypropylene (PP), diacetyl cellulose, polyvinyl chloride, an epoxy resin, a urea resin, a urethane resin, a melamine resin, a cyclic olefin polymer (COP), a norbornene-based thermoplastic resin, and the like.

The conductive layers 31b and 34b are at least needed to be electrically conductive, and for example, an inorganic conductive layer including an inorganic conductive material, an organic conductive layer including an organic conductive material, an organic-inorganic conductive layer including both of the inorganic conductive material and the organic conductive material, and the like can be used.

Examples of the inorganic conductive material can include a metal, a metal oxide, and the like. Here, the metal is defined to include semimetal. Examples of the metal can include metals such as aluminum, copper, silver, gold, platinum, palladium, nickel, tin, cobalt, rhodium, iridium, iron, ruthenium, osmium, manganese, molybdenum, tungsten, niobium, tantelum, titanium, bismuth, antimony, and lead, or an alloy of these metals, but note limited thereto. Examples of the metal oxide can include an indium tin oxide (ITO), a zinc oxide, an indium oxide, an antimony added tin oxide, a fluorine added tin oxide, an aluminum added zinc oxide, a gallium added zinc oxide, a silicon added zinc oxide, a zinc oxide-tin oxide series, an indium oxide-tin oxide series, a zinc oxide-indium oxide-magnesium oxide series, and the like, but not limited thereto.

Examples of the organic conductive material can include a carbon material, a conductive polymer, and the like. Examples of the carbon material can include carbon black, a carbon fiber, fullerene, graphene, carbon nanotube, carbon microcoil, nanohorn, and the like, but not limited thereto. As the conductive polymer, for example, a substituted or unsubstituted polyaniline, polypyrrole, polythiophene, a (co)polymer including one or two kinds selected from these, or the like can be used, but not limited thereto.

Note that the REF electrode layers 31 and 34 may also include only the conductive layers 31b and 34b without including the base materials 31a and 34a. In this case, the REF electrode layers 31 and 34 may be metal plates. Additionally, the REF electrode layer 31 provided on the back surface side of the sensor 30a may be omitted. In this case, preferably, a REF electrode layer is separately provided inside the housing 20 such that the REF electrode layer is positioned on the back surface side of the sensor 30a.

(Bond Layer)

The bond layer 35 includes, for example, an adhesive or a double-sided adhesive tape having an insulation property. As the adhesive, for example, one or more kinds selected from a group including an acrylic adhesive, a silicone adhesive, a urethane adhesive, and the like can be used. Here, pressure sensitive adhesion is defined as a kind of adhesion. According to this definition, an adhesive layer is deemed as one kind of the bond layer.

Sensor Layer

The sensor layer 32 is provided between the REF electrode layers 31 and 34 and detects, as a capacitance change, a change in a distance from the REF electrode layer 34 located on the sensing surface 30Sa side, and outputs the detected capacitance change to the controller IC 12a. Specifically, the sensor layer 32 includes a plurality of nodes ND constituting two rows, and the plurality of nodes ND detects a change in the distance between the sensor layer 32 and the REF electrode layer 31 as a capacitance change, and outputs the detected capacitance change to the controller IC 12a.

The sensor layer 32 is a capacitive sensor layer, and as illustrated in FIG. 9, includes a base material 32a, a plurality of first electrodes (sense electrodes) 32EY provided on a back surface of the base material 32a, an insulating layer 32b covering these first electrodes 32EY, a bond layer 32c provided on a front surface side of the base material 32a, a base material 32d bonded to the front surface of the base material 32a via the bond layer 32c, and a plurality of second electrodes (pulse electrodes) 32EX provided on a back surface side of the base material 32d. Each node ND includes a portion where a first electrode 32EY overlaps with a second electrode 32EX or a portion where both of the electrodes intersect when viewed from the thickness direction of the sensor 30a.

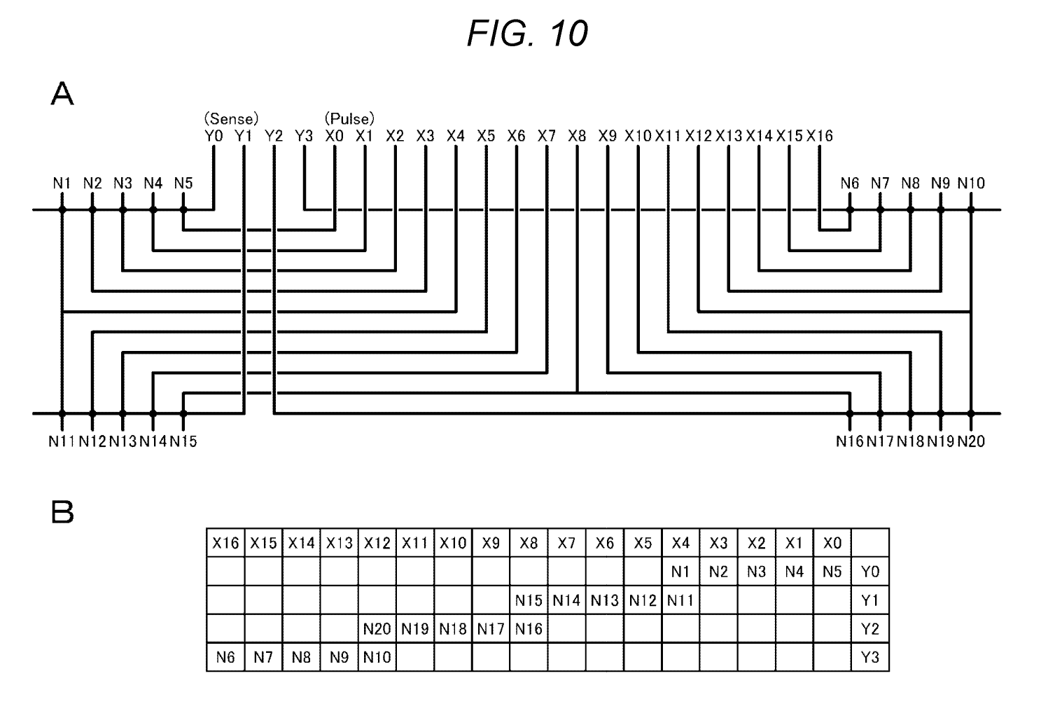

In the following, exemplary configurations of the first and second electrodes 32EY and 33EX will be described with reference to FIGS. 10A and 10B. Here, described is an example in which twenty nodes ND are constituted of overlapping portions of four first electrodes 32EY and seventeen second electrodes 32EX. In FIG. 10A, note that reference signs “Y0, Y1, Y2, and Y3” are used instead of the reference sign “32EY” in order to identify each one of the four first electrodes 32EY. Similarly, reference signs “X0, X1, . . . , X15, and Y16” are used instead of the reference sign “32EX” in order to identify each one of the seventeen second electrodes 32EX.

The first electrodes Y0 and Y1 are arranged in parallel apart from each other at a predetermined interval. The second electrodes X0, X1, X3, and X4 are led to a region between the first electrodes Y0 and Y1 arranged in parallel, and then made to intersect with the first electrode Y0 and led out from the region. The second electrodes X4, X5, X6, X7, and X8 are led to the region between the first electrodes Y0 and Y1 arranged in parallel, and then made to intersect with the first electrode Y1 and led out from the region.

The first electrodes Y2 and Y3 are arranged in parallel apart from each other at a predetermined interval. The second electrodes X8, X9, X10, X11, and X12 are led to a region between the first electrodes Y2 and Y3 arranged in parallel, and then made to intersect with the first electrode Y2 and led out from the region. The second electrodes X12, X13, X14, X15, and X16 are led to the region between the first electrodes Y2 and Y3 arranged in parallel and then made to intersect with the first electrode Y3 and led out from the region.

As described above, the second electrodes X0, X1, . . . , X15, and X16 are wired so as to be led to the region between the first electrodes Y0 and Y1 and the region between the first electrodes Y2 and Y3, and therefore, a space necessary for wiring can be more reduced than in a case where the second electrodes X0, X1, . . . , X15, and X16 are wired so as to be led to the outside of the region between the first electrodes Y0 and Y1 and the outside of the region between the first electrodes Y2 and Y3.

Nodes N1, N2, N3, N4, and N5 are constituted of overlapping portions of the first electrode Y0 and the second electrodes X0, X1, X3, and X4, respectively. Nodes N11, N12, N13, N14, and N15 are constituted of overlapping portions of the first electrode Y1 and the second electrodes X4, X5, X6, X7, and X8, respectively. Nodes N16, N17, N18, N19, and N20 are constituted of overlapping portions of the first electrode Y2 and the second electrodes X8, X9, X10, X11, and X12, respectively. Nodes N6, N7, N8, N9, and N10 are constituted of overlapping portions between the first electrode Y3 and the second electrodes X12, X13, X14, X15, and X16, respectively.

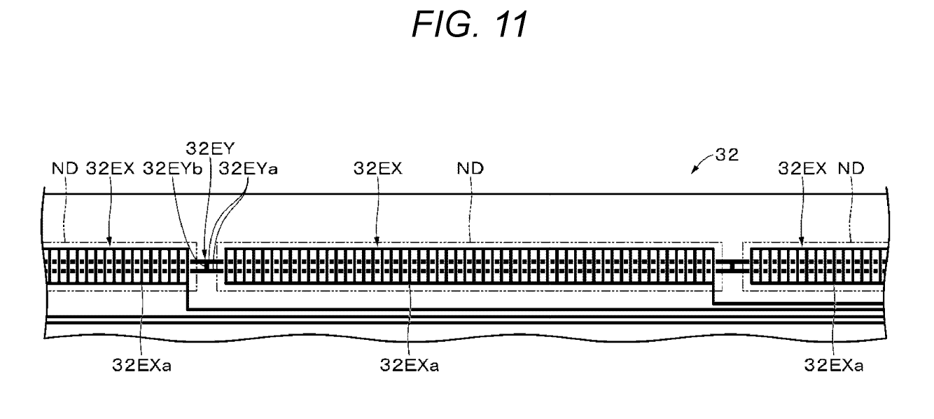

As illustrated in FIG. 11, each first electrode 32EY includes two linear electrode lines 32EYa extending in the longitudinal direction of the sensor 30a. The two electrode lines 32EYa are provided in parallel, and the adjacent electrode lines 32EYa are electrically connected by a connecting portion 32EYb. With this structure, a function as the sensor 30a is maintained even in a case where one of the two electrode wires 32EYa provided in parallel is disconnected. Therefore, durability of the sensor 30a is improved.

Each second electrode 32EX includes an electrode body 32EXa including a linear electrode element. The electrode body 32EXa has, for example, a comb-like shape, a ladder-like shape, or a mesh-like shape. The electrode body 32EXa is provided in a manner overlapping with the electrode line 32EYa in the thickness direction of the sensor 30a. Each node ND is constituted of an overlapping portion or an intersecting portion of the electrode line 32EYa and the electrode body 32EXa.

The base materials 32a and 32d are similar to the above-described base materials 31a and 34a.

As a material of the insulating layer 32b, for example, an ultraviolet curable resin, a thermosetting resin, an insulating resist, a metal compound, or the like can be used. Specifically, for example, a resin material such as polyacrylate, polyvinyl alcohol (PVA), polystyrene (PS), polyethylene terephthalate (PET), polyimide, polyester, epoxy, polyvinyl phenol, and polyvinyl alcohol, and metal compounds such as SiO₂, SiNx, SiON, Al₂O₃, Ta₂O₅, Y₂O₃, HfO₂, HfAlO, ZrO₂, and TiO₂ can be used.

The bond layer 32c is similar to the bond layer 35.

(Structural Layer)

The structural layer 33 is provided between the two rows of nodes ND when viewed from the thickness direction of the sensor 30a, and includes a structural body 33a that separates the REF electrode layer 34 from the sensor layer 32. The structural body 33a extends between the two rows of the node ND when viewed from the thickness direction of the sensor 30a. Specifically, the structural body 33a is a continuous body extending in the longitudinal direction of the sensor 30a at a center position in a short direction of the sensor 30a. Empty space portions 33d and 33d are provided respectively on both sides of the structural body 33a in the short direction of the sensor 30a. The node ND is provided at position overlapping with the empty space portion 33d in the thickness direction of the sensor 30a. The empty space portion 33d is provided between the row of the nodes ND and the REF electrode layer 34. Preferably, the empty space portions 33d and 33d are separated by the structural body 33a. The reason is that detection accuracy for pressing force applied to the sensing area 30Ra is improved because, in a case where pressing force is applied to a side of the sensing area 30Ra, a difference between capacitance changes detected in nodes ND respectively located in the two rows and most adjacent to each other becomes large. Preferably, both sides (both sides in the short direction) of the structural layer 33 are open. The reason is that detection accuracy for pressing force applied to the sensing area 30Ra is improved because, in a case where pressing force is applied to a side of the sensing area 30Ra, a difference between capacitance changes detected in nodes ND respectively located in the two rows and most adjacent to each other becomes large.

As illustrated in FIG. 9, the structural body 33a includes a structural portion 33b and a joint portion 33c. The structural portion 33b is a columnar body having a cross section of a trapezoidal shape, a rectangular shape, a semicircular shape, or the like. The joint portion 33c is provided on a top portion of the structural portion 33b, and the structural portion 33b and the REF electrode layer 31 are bonded to each other via the joint portion 33c. As a material of the structural portion 33b, a resin material having an insulation property is used, for example. As such a resin material, a photo-curable resin such as an ultraviolet curable resin can be used, for example. As a material of the joint portion 33c, an adhesive resin material or the like is used, for example.

Note that the configuration of the structural body 33a is not limited to the configuration in which the structural portion 33b and the joint portion 33c are separately formed as described above, and the structural portion 33b and the joint portion 33c may be integrally formed in advance. In this case, a material capable of achieving both functions of the structural portion 33b and the joint portion 33c is selected as a material of the structural body 33a, for example.

### 1.6 Detecting Operation of Sensor

Exemplary detecting operation of the sensor 30a will be described below with reference to FIGS. 8C and 9. When pressing force is applied to the sensing area 30Ra by a finger or the like, the sensing area 30Ra of the housing 20 is bent. Pressing force is applied to the sensing surface 30Sa via the projecting portions 30TP and 30TP by such bending. Consequently, a distance between the REF electrode layer 34 and the sensor layer 32 is changed. At this point, portions located above the empty space portions 33d and 33d out of the REF electrode layer 34 are largely displaced toward the sensor layer 32 compared to remaining portions thereof. Since such largely-displaced portions moves closest to the nodes ND, high detection sensitivity can be obtained.

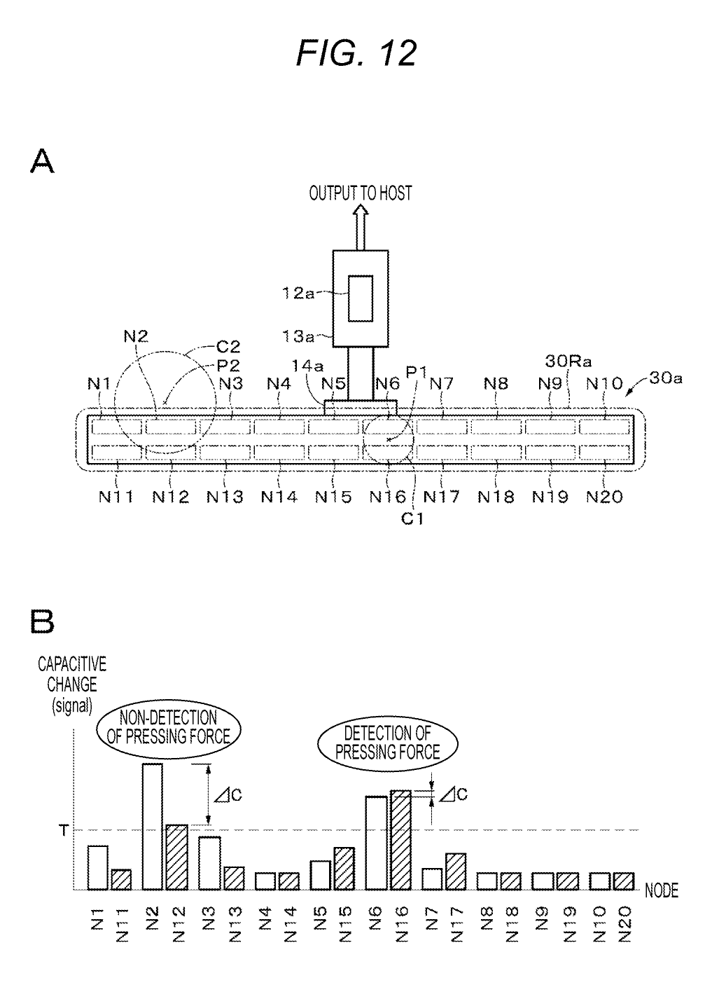

Since the structural body 33a is provided between the two rows of the nodes ND when viewed from the thickness direction of the sensor 30a, following features can be obtained (refer to FIGS. 12A and 12B). In other words, in a case where pressing force is applied to the sensing area 30Ra, capacitance changes in nodes ND respectively located in the two rows and most adjacent to each other are substantially equal (refer to nodes N6 and N16 in FIG. 12B). In contrast, in a case where pressing force is applied to a side position of the sensing area 30Ra, capacitance changes in the nodes ND respectively located in the two rows and most adjacent to each others are largely different from each other. In other words, among the nodes ND that are respectively located in the two rows and most adjacent to each other, a capacitance change tends to be large in a node ND closer to a position where pressing force is applied, whereas a capacitance change tends to be small in a node ND located distant from the position where pressing force is applied (refer to nodes N2 and N12 in FIG. 12B). The reason is that the REF electrode layer 34 is supported by the structural body 33a provided at the position between the two rows of the nodes ND.

### 1.7 Pressing Force Detecting Operation

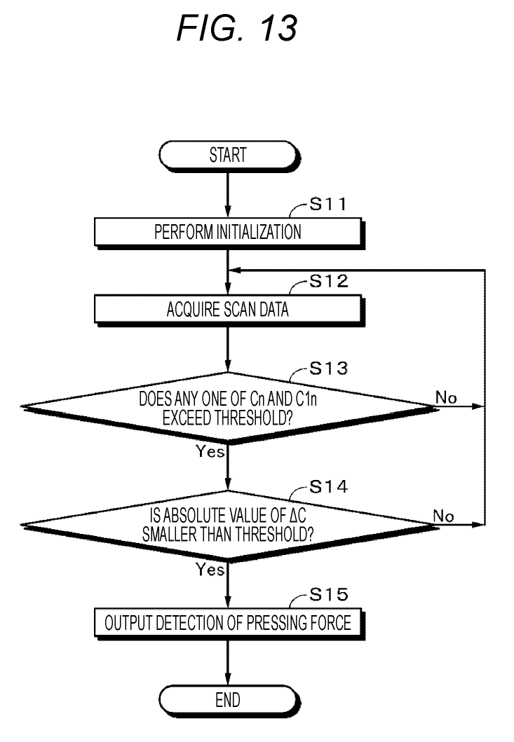

Exemplary pressing force detecting operation in the controller IC 12a will be described below with reference to FIGS. 10A, 10B, 12A, 12B, and 13. Here, the pressing force detecting operation in the controller IC 12a will be described, but the pressing force detecting operation in the controller IC12b is also similar.

First, in step S11, when power of the electric apparatus 10 is applied, the host 11 that is the main body of the electric apparatus 10 initializes the controller IC 12a. Next, in step S12, the controller IC 12a sequentially applies a predetermined pulse (voltage) to the second electrodes X0, X1, . . . , and X16 and sequentially scans the second electrodes X0, X1, . . . , and X16, thereby detecting capacitance changes in the nodes N1 to N20 (specifically, distribution of the capacitance changes) (refer to FIGS. 10A, 10B, 12A, and 12B).

Next, in step 13, the controller IC 12a determines whether there is any pair having capacitance changes Cn and C1n exceeding a threshold T (note that Cn and C1n respectively indicate the capacitance changes in the nodes Nn and N1n) among the respective pairs of nodes Nn and N1n (note that n is an integer of 1 or more and 10 or less) facing each other in the short direction of the sensor 30a (refer to FIGS. 12A and 12B). At this point, determination may be made on whether one of the capacitance changes Cn and C1n of the nodes Nn and N1n constituting one pair exceeds the threshold T, or determination may be made on whether both thereof exceed the threshold T.

In step S13, in a case where the controller IC 12a determines that there is a pair having the capacitance changes Cn and C1n exceeding the threshold T, the controller IC 12a determines, in step S14, whether an absolute value |ΔC| (=|Cn−C1n|) of the difference between the capacitance changes in the pair of nodes Nn and N1n determined to have the capacitance changes exceeding the threshold T exceeds a threshold (|ΔT|) (refer to FIG. 12B). On the other hand, in a case where the controller IC 12a determines in step S13 that there is no pair having the capacitance changes Cn and C1n exceeding the threshold T, the processing returns to step S12.

In step S14, in a case where the controller IC 12a determines that the absolute value |ΔC| of the difference between the capacitance changes exceeds the threshold |ΔT|, the processing returns to step S12. On the other hand, in a case where the controller IC 12a determines in step S14 that the absolute value |ΔC| of the difference between the capacitance changes does not exceed the threshold |ΔT|, the controller IC 12a notifies, in step S15, the host 11 of a fact that pressing force applied to the sensing area 30Ra is detected. When the fact that the pressing force applied to the sensing area 30Ra is detected is notified to the host 11, predetermined processing such as cancellation of sleep processing is executed.

### 1.8 Effects

The electric apparatus 10 according to the first embodiment includes: the second housing 22 having the recessed portions 23a and 23b on the inner surface 22SI; and the pressure sensitive sensors 30a and 30b provided in the recessed portions 23a and 23b. Consequently, when pressing force is applied by a finger and the like to the sensing areas 30Ra and 30Rb set on the back side of the bottom surfaces 23S of the recessed portions 23a and 23b, the bottom surfaces of the recessed portions 23a and 23b are bent and pressing force is applied to the sensing surfaces 30Sa of the sensors 30a and 30b by the bottom surfaces 23S of the recessed portions 23a and 23b. Therefore, the sensors 30a and 30b can detect pressing force applied to the sensing areas 30Ra and 30Rb.

Additionally, each of the sensors 30a and 30b includes: the flexible REF electrode layer 34; the sensor layer 32 provided in a manner facing the REF electrode layer 34 and including the two rows of nodes ND; and the structural body 33a which is provided between the two rows of nodes ND when viewed from the thickness direction of the sensor 30a, and separates the REF electrode layer 34 from the sensor layer 32. In each of the sensors 30a and 30b having such a configuration, in a case where pressing force is applied to each of the sensing areas 30Ra and 30Rb, a difference between capacitance changes detected in the nodes ND respectively located in the two rows and adjacent to each other is small. On the other hand, in a case where pressing force is applied to a side portion of the sensing area 30Ra, a difference between capacitance changes detected in the nodes ND respectively located in the two rows and adjacent to each other is large. Therefore, the sensors 30a and 30b can output capacitance changes (more specifically, distribution of capacitance changes) by which pressing force applied to the sensing areas 30Ra and 30Rb and pressing force applied to the outside of the sensing areas 30Ra and 30Rb can be determined.

Furthermore, the controller ICs 12a and 12b determine whether capacitance changes output from respective nodes ND constituting the two rows exceed a first threshold, and in a case where the capacitance changes exceed the first threshold, pressing force applied to the sensing areas 30Ra and 30Rb and pressing force applied to the outside of the sensing areas 30Ra and 30Rb are determined on the basis of whether a difference between capacitance changes in the nodes ND respectively located in the two rows and adjacent to each other exceeds a second threshold. Therefore, pressing force applied to the sensing areas 30Ra and 30Rb is correctly detected.

### 1.9 Modified Examples

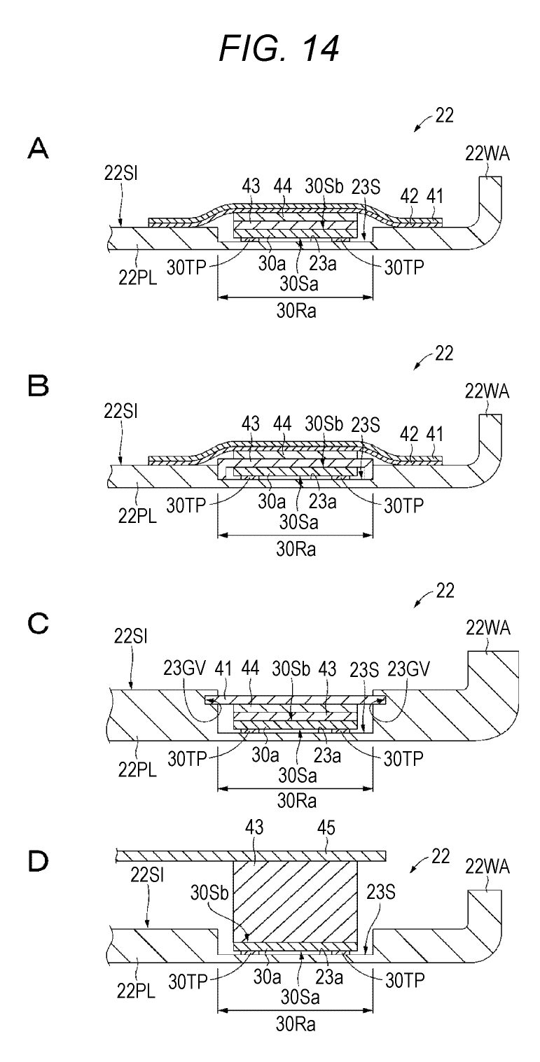

As illustrated in FIG. 14A, a support plate 43 provided between the sensor 30a and the fixation plate 41 and functioning as a support layer, and an elastic layer 44 provided between the fixation plate 41 and the support plate 43 may be further provided. Note that only the support plate 43 may be provided between the sensor 30a and the fixation plate 41 although not illustrated.

The support plate 43 is provided in order to support the back surface 30Sb of the sensor 30a. Preferably, the support plate 43 is more hardly deformed than the sensor 30a is. In other words, preferably, the support plate 43 has rigidity higher than that of the sensor 30a. The reason is that detection sensitivity of the sensing area 30Ra can be improved.

The support plate 43 includes, for example, a polymer resin or a metal. A spring plate 27a may have a layered structure including a polymer resin layer and a metal layer. As the polymer resin, a material similar to those of the base materials 31a and 34a can be exemplified. As the metal, a material similar to that of the housing 20 can be exemplified.

The elastic layer 44 includes rubber like urethane foam, for example. An adhesive layer may be provided on one side or both sides of the elastic layer 44. The elastic layer 44 has, for example, a sheet-like shape, but not limited thereto.

As illustrated in FIG. 14B, the support plate 43 may have a U-shaped cross section. In this case, the support plate 43 is fitted into the recessed portion 23a of the second housing 22 so as to house the sensor 30a in a recessed portion thereof. The support plate 43 fixes the sensor 30a in the recessed portion 23a so as to keep a contacting state between the sensing surface 30Sa of the sensor 30a and the bottom surface 23Sa of the recessed portion 23a. From the viewpoint of improving the detection sensitivity of the sensing area 30Ra, preferably, the support plate 43 is a pressing member that fixes the sensor 30a in the recessed portion 23a by pressing the sensor 30a against the bottom surface 23Sa of the recessed portion 23a. In this case, the fixation plate 41 may not be necessarily provided.

As illustrated in FIG. 14C, grooves 23GV may be provided on both side surfaces of the recessed portion 23a such that both ends of the plate-shaped fixation plate 41 are fitted into the grooves 23GV. In this case, at least one of the support plate 43 and the elastic layer 44 may be provided between the sensor 30a and the fixation plate 41 as needed.

As illustrated in FIG. 14D, the support plate 43 may be fixed to the support 45. As the support body 45, members such as a panel, a substrate, or the like housed inside the housing 20, the first housing 21 constituting the housing 20, and the like can be exemplified.

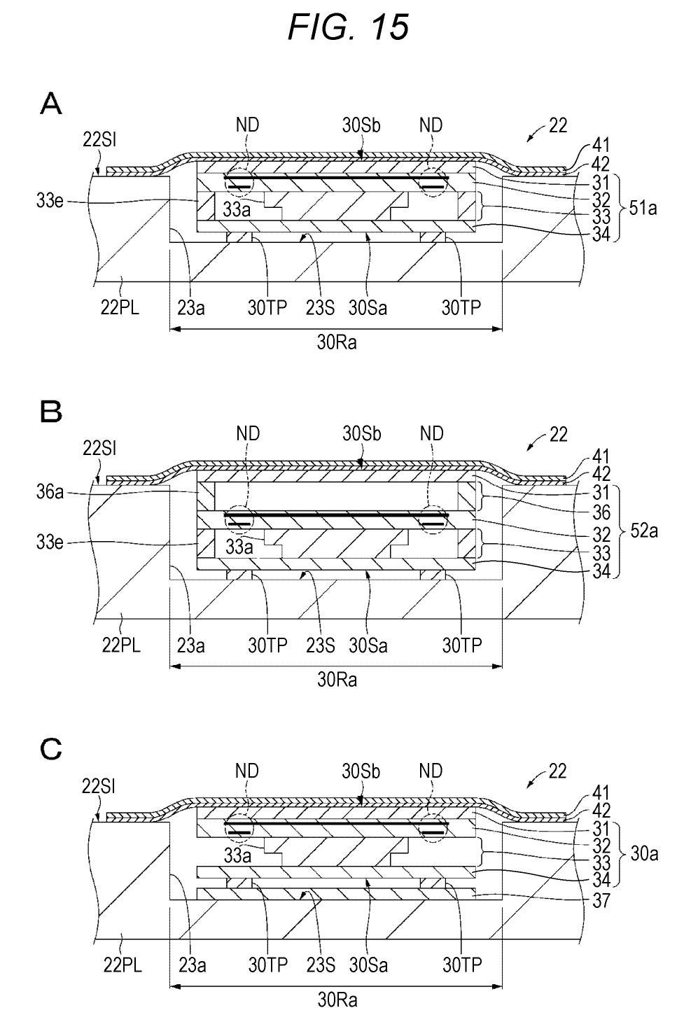

As illustrated in FIG. 15A, a sensor 51a may include the structural layer 33 including a structural body 33e in a peripheral edge portion between the sensor layer 32 and the REF electrode layer 34. The structural body 33e may be a frame body continuously provided in the peripheral edge portion between the sensor layer 32 and the REF electrode layer 34 or may be a frame body intermittently provided in the peripheral edge portion between the sensor layer 32 and the REF electrode layer 34. The structural body 33e may have a height lower than a height of the structural body 33a, and a gap may be provided between a top portion of the structural body 33e and the REF electrode layer 34 or a gap may be provided between the top portion of the structural body 33e and the sensor layer 32.

As illustrated in FIG. 15B, a sensor 52a may further include a structural layer 36 between the REF electrode layer 31 and the sensor layer 32. The structural layer 36 includes a structural body 36a provided at a peripheral edge portion between the REF electrode layer 31 and the sensor layer 32. Although not illustrated, the structural layer 36 may include, in a center position in the short direction of the sensor 30a, a structural body that extends in the longitudinal direction of the sensor 30a, instead of the above-described structural body 36a or together with the structural body 36a.

As illustrated in FIG. 15C, the sensor 30a may be bonded to the bottom surface 23S of the recessed portion 23a via the bond layer 37. In this case, the fixation plate 41 may not be necessarily provided.

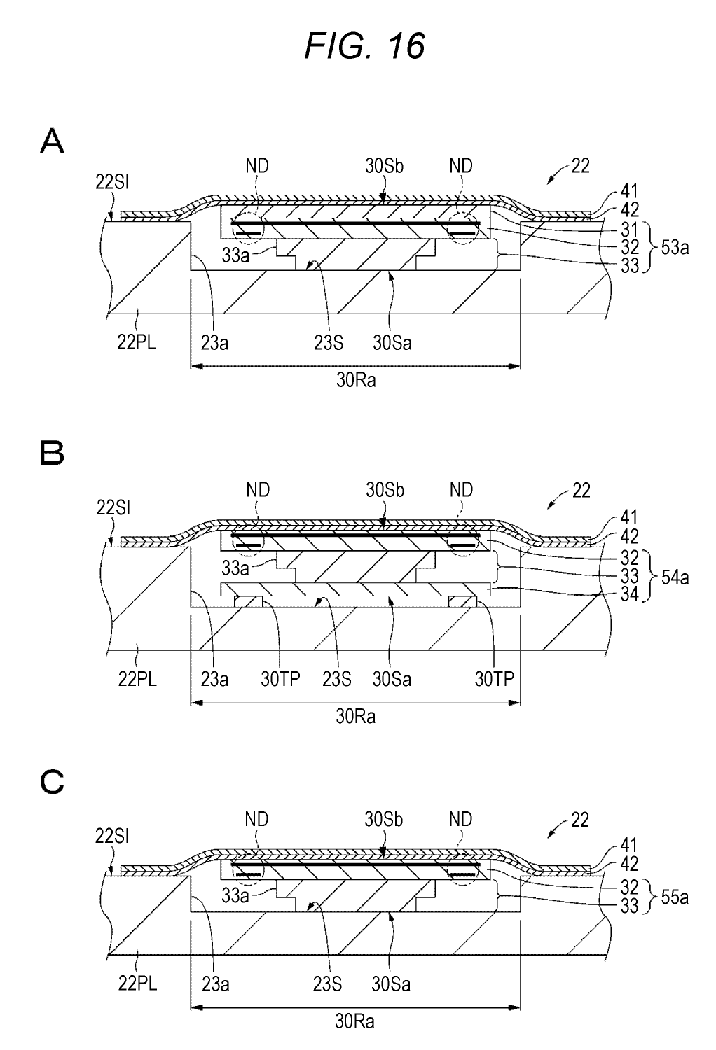

As illustrated in FIG. 16A, a sensor 53a may not include the REF electrode layer 34 (refer to FIG. 8C). In a case of using the sensor 53a, a top portion of each of the plurality of structural bodies 33a is fixed inside the recessed portion 23a so as to contact the bottom surface 23S of the recessed portion 23a. In this case, a portion of the bottom surface 23S of the recessed portion 23a functions as the REF electrode layer (conductive layer). Therefore, at least the portion of bottom surface 23S of the recessed portion 23a is conductive in the second housing 22. Specifically, for example, the entire second housing 22 or the inner surface 22SI of the second housing 22 may be conductive, or only the inner surface of the recessed portion 23a or only the bottom surface 23S of the recessed portion 23a may be conductive in the second housing 22. The second housing 22 that is entirely conductive may be a metal housing including a metal.

In the case where the inner surface 22SI of the second housing 22 is conductive, a conductive layer is provided on the inner surface 22SI. In the case where only the inner surface of the recessed portion 23a or only the bottom surface 23S of the recessed portion 23a is conductive in the second housing 22, a conductive layer is provided on the inner surface of the recessed portion 23a or the bottom surface 23S of the recessed portion 23a. The conductive layer is, for example, a conductive layer obtained by drying and curing a plating layer, a vapor deposition layer, a sputtering layer, a metal foil, a conductive paste, or the like.

In the sensor 53a having the above-described configuration, the portion of bottom surface 23S of the second housing 22 is used as the REF electrode layer 34, and therefore, the configuration of the sensor 51a can be simplified and thinned.

As illustrated in FIG. 16B, a sensor 54a may not include the REF electrode layer 31 (refer to FIG. 8C). In this case, the fixation plate 41 functions as a REF electrode layer (conductive layer). Therefore, at least the surface of the fixation plate 41 facing the sensor layer 32 is conductive. Specifically, for example, the entire fixation plate 41 may be conductive, or only the surface of the fixation plate 41 facing the sensor layer 32 may be conductive.

In the case where the entire fixation plate 41 is conductive, the fixation plate 41 includes a conductive material. In the case where only the surface of the fixation plate 41 facing the sensor layer 32 is conductive, a conductive layer is provided on the surface facing the sensor layer 32. The conductive layer is, for example, a conductive layer obtained by drying and curing a plating layer, a vapor deposition layer, a sputtering layer, a metal foil, a conductive paste, or the like.

In the sensor 54a having the above-described configuration, the fixation plate 41 is used as the REF electrode layer 31, and therefore, the configuration of the sensor 54a can be simplified and thinned.

As illustrated in FIG. 16C, a sensor 55a may not include both of the REF electrode layers 31 and 34 (refer to FIG. 8C).

In the sensor 55a having the above-described configuration, the portion of bottom surface 23S of the recessed portion 23a is used as the REF electrode layer on the front surface side, and the fixation plate 41 is used as the REF electrode layer on the back surface side, and therefore, the configuration of the sensor 52a is simplified and thinner.

No projecting portion 30TP may be provided on the sensing surface 30Sa. In this case, preferably, a material having a low elastic modulus is used as the structural body 33a. The reason is that detection sensitivity of the sensor 30a can be improved.

The sensor 30a may include only one pair of nodes ND facing each other. In this case, the sensor 30a may be provided at a corner portion or a predetermined position of a side portion of the second housing 22, a predetermined position of the main surface portion 22PL, or the like. In this case, pressing force applied to a predetermined portion such as the corner portion of the second housing 22 can be detected with high accuracy.

In the first embodiment, the case where each pair of the nodes Nn and N1n having capacitance changes to be compared faces each other in the short direction of the sensor 30a has been described, but each pair of the nodes Nn and N1n having capacitance changes to be compared may not necessarily face each other in the short direction of the sensor 30a and may be displaced from each other in the longitudinal direction of the sensor 30a. In this case, the controller IC 12a may compare capacitance changes in the nodes Nn and N1n located most adjacent to each other. In a case where two nodes N1n and N1n+1 are located most adjacent to the node Nn, the controller IC 12a may compare capacitance changes in the most adjacent two nodes which are a pair of Nn and N1n and a pair of Nn and N1n+1, or may compare capacitance changes in any predetermined pair out of the pair of nodes Nn and N1n and the pair of nodes Nn and N1n+1.

In the first embodiment, the case where the two rows of the nodes ND extend linearly in the longitudinal direction of the sensor 30a has been described, but the two rows of the nodes ND may be rows meandering in the short direction of the sensor 30a (for example, zigzag rows).

In the first embodiment, the case where the structural body 33a is the continuous body extending in the longitudinal direction of the sensor 30a has been described, but the structural body 33a may be a discontinuous body provided intermittently. Additionally, the plurality of structural bodies 33a may be arranged in the longitudinal direction at the center position in the short direction of the sensor 30a. In this case, for example, each of the structural bodies 33a may have a conical shape, a columnar shape (for example, a columnar shape or a polygonal columnar shape), a needle-like shape, a partial shape of a sphere (for example, a hemispherical shape), a partial shape of an ellipsoid (for example, semi-ellipsoid shape), a polygonal shape, or the like, but not limited thereto, other shapes may also be adopted.

The first and second electrodes 32EY and 32EX may be formed inside the same plane. In this case, the first and second electrodes 32EY and 32EX include the comb-shaped first and second electrode bodies respectively such that the first and second comb-shaped electrode bodies are engaged with each other.

In the first embodiment, the example in which the sleep mode is canceled by the pressing force applied to the sensing areas 30Ra and 30Rb has been described, but other operation of the electric apparatus 10 other than this operation may also be executed by the pressing force applied to the sensing areas 30Ra and 30Rb. For example, adjustment of output sound volume, adjustment of brightness of a screen, hereafter to sleep operation, and the like may be executed by the pressing force applied to the sensing areas 30Ra and 30Rb.

The controller ICs 12a and 12b determine whether pressing force is continuously applied to the sensing area 30Ra for a predetermined period or longer on the basis of capacitance changes supplied from the sensors 30a and 30B, and only in a case where application of the pressing force is continued for the predetermined period or longer, such pressing force applied to the sensing area 30Ra may be notified to the host 11. In this case, it is possible to reduce false operation in a case where a user unintentionally applies pressing force to the sensing area 30Ra.

The controller ICs 12a and 12b determine whether the pressing force applied to the sensing area 30Ra is detected a predetermined number of times within a predetermined period on the basis of capacitance changes supplied from the sensors 30a and 30B, and only in a case where the pressing force is detected the predetermined number of times within the predetermined period, the pressing force applied to the sensing area 30Ra may be notified to the host 11. In this case also, the advantages similar to those described above can be obtained.

In the first embodiment, the example in which the sensors 30a and 30b are provided in the recessed portions 23a and 23b included in the second housing 22 has been described, but the recessed portions 23a and 23b may not be necessarily provided. Additionally, side surfaces of the recessed portions 23a and 23b may be curved surfaces or inclined surfaces.

The housing 20 is an example of a bendable base material, and the sensor 30a can be used for various kinds of bendable base materials. A surface on which the sensor 30a is provided is not limited to a flat surface, and may also be a curved surface, a bent surface, a wave surface, or the like. Additionally, the shape of the base material is not limited to a flat plate shape, and may also be a curved plate shape, a bent plate shape, a corrugated plate shape, or the like.

In the above-described first embodiment, the exemplary case where the electric apparatus is a tablet computer has been described, but the present technology is not limited thereto and can be applied to various kinds of electric apparatuses each having an exterior body such as a housing. For example, the first embodiment is also applicable to a personal computer, a mobile phone such as a smartphone, a television, a remote controller, a camera, a game machine, a navigation system, an electronic book, an electronic dictionary, a portable music player, a wearable terminal such as a smart watch or a head mound display, a radio, an electric tool, a refrigerator, an air conditioner, a wearable apparatus, a stereo, a water heater, a microwave oven, a dishwasher, a washing machine, a dryer, a lighting device, a toy, a medical apparatus, a robot, and the like. Note that a so-called electronic apparatus is also included in the electric apparatuses.

Furthermore, the present technology is not limited to the electric apparatuses and applicable to various items other than the electric apparatuses. For example, the present technology is applicable to buildings such as a house, a building member, a vehicle, furniture such as a table and a desk, a manufacturing device, an analytical instrument, and the like. Examples of the building member can include a paving stone, a wall material, a floor tile, a floor board, and the like. Examples of the vehicle can include a vehicle (for example, a car, a motorcycle, and the like), a ship, a submarine, a railroad vehicle, an aircraft, a spacecraft, an elevator, playground equipment, and the like.

### 2. Second Embodiment

### 2.1 Configuration of Electric Apparatus

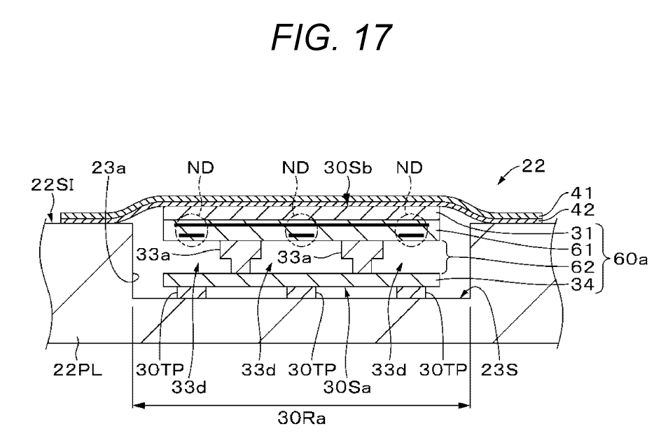

As illustrated in FIG. 17, in an electric apparatus 10 according to a second embodiment of the present technology, a sensor 60a includes: a sensor layer 61 including a plurality of nodes ND arranged in three rows; and a structural layer 62 including structural bodies 33a and 33a each provided between the respective rows of the nodes ND when viewed from a thickness direction of the sensor 60a. Empty space portions 33d are provided between the respective rows of the node ND and a REF electrode layer 34. Additionally, the REF electrode layer 34 is supported by the structural bodies 33a provided at positions between the respective rows of the nodes ND. A sensing surface 30Sa is provided with three projecting portions 30TP extending in a longitudinal direction of the sensor 60a and located apart from each other at a predefined interval. Each of the projecting portions 30TP is provided at a position where each of the empty space portions 33d overlaps with each of the rows of the nodes ND when viewed from the thickness direction of the sensor 60a.

In the electric apparatus 10 having the above-described configuration, when pressing force is applied to the sensing area 30Ra is by a finger or the like, the sensing area 30Ra of the housing 20 is bent. Pressing force is applied to the sensing surface 30Sa via the projecting portions 30TP by such bending. Consequently, a distance between each of the nodes ND and the REF electrode layer 34 is displaced in a position where pressing force is applied and the vicinity thereof, and capacitance in each of the nodes ND is changed. On the other hand, when pressing force is applied to a side position of the sensing area 30Ra by a finger or the like, the housing 20 is bent around the position. In a case where the bent portion extends to the sensing area 30Ra, pressing force results in being applied to the sensing surface 30Sa via the projecting portions 30TP. In this case, a node ND located closer to a center position of the pressing force tends have a shorter distance from the REF electrode layer 34, and a capacitance change tends to be large.

Controller ICs 12a and 12b perform comparison of capacitance changes in the nodes ND between the three rows, and determines pressing force applied to sensing areas 30Ra and 30Rb. More specifically, whether pressing force is applied to the sensing areas 30Ra and 30Rb is determined by comparing capacitance changes in three nodes ND adjacent in a direction between the rows of the nodes ND (short direction of the sensor 60a).

### 2.2 Pressing Force Detecting Operation

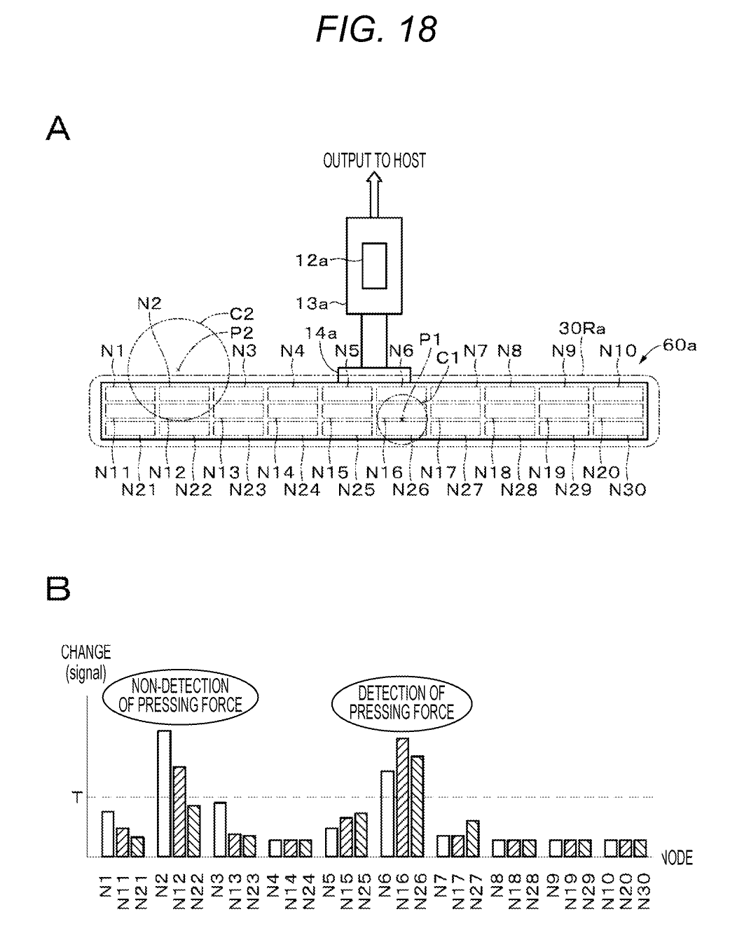

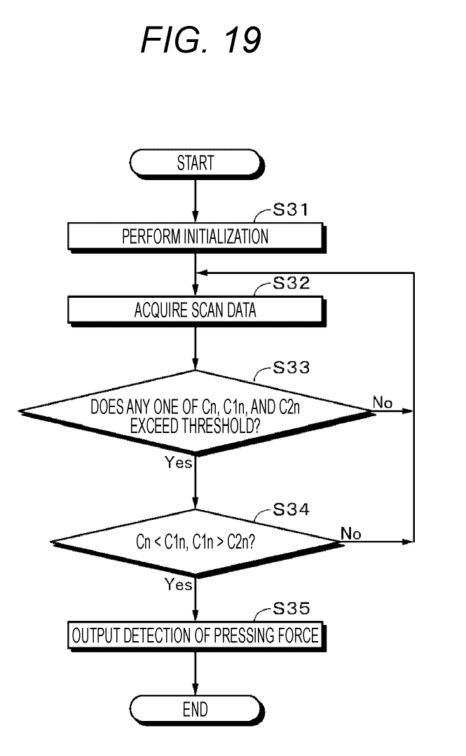

In the following, exemplary pressing force detecting operation in the controller IC 12a will be described with reference to FIGS. 18A, 18B, and 19.

First, in step S31, when power of the electric apparatus 10 is applied, a host 11 that is a main body of the electric apparatus 10 initializes the controller IC 12a. Next, in step S32, the controller IC 12a sequentially applies a predetermined pulse (voltage) to a plurality of second electrodes 32EX included in the sensor 60a and sequentially scans the second electrodes 32EX, thereby detecting capacitance changes in nodes N1 to N30 (more specifically, distribution of capacitance changes) (refer to FIGS. 18A and 18B).

Next, in step 33, the controller IC 12a determines whether there is any set having capacitance changes Cn, C1n, and C2n exceeding a threshold T (note that Cn, C1n, and C2n respectively indicate capacitance changes in the nodes Nn, N1n, and N2n) among sets of the nodes Nn, N1n, and N2n (note that n is an integer of 1 or more and 10 or less) adjacent to one another in the short direction of the sensor 60a (refer to FIGS. 18A and 18B) At this point, determination may be made on whether at least one of the capacitance changes Cn, C1n, and C2n in the nodes Nn, N1n, and N2n constituting the one set exceeds the threshold T, or determination may be made on whether at least two capacitance changes exceed the threshold T, or also determination may be made on whether all of the three capacitance changes exceed the threshold T.

In a case where the controller IC 12a determines that the capacitance changes Cn, C1n, and C2n exceed the threshold T in step S33, the controller IC 12a determines in step S34 whether the set of Cn, C1n, and C2n determined to exceed the threshold T satisfy relations of Cn<C1n and C1n>C2n. On the other hand, in a case where the controller IC 12a determines in step S33 that the capacitance changes Cn, C1n, C2n do not exceed the threshold T, the processing returns to step S32.

In a case where the controller IC 12a determines in step S34 that the relations Cn<C1n and C1n>C2n are satisfied, the controller IC 12a notifies the host 11 of a fact that pressing force applied to the sensing area 30Ra is detected in step S34. On the other hand, in a case where the controller IC 12a determines in step S34 that the relations Cn<C1n and C1n>C2n are not satisfied, the processing returns to step S32.

### 2.3 Effects

The electric apparatus 10 according to the first embodiment has three rows in the sensor 60a, and determination is made on whether a load center exists inside the sensing area 30Ra on the basis of capacitance changes Cn, C1n, and C2n in nodes Nn, N1n, and N2n constituting each set and arranged in a width direction of the sensor 60a. Therefore, whether the load center exists inside the sensing area 30Ra can be more correctly determined.

### 3. Third Embodiment

### 3.1 Configuration of Electric Apparatus

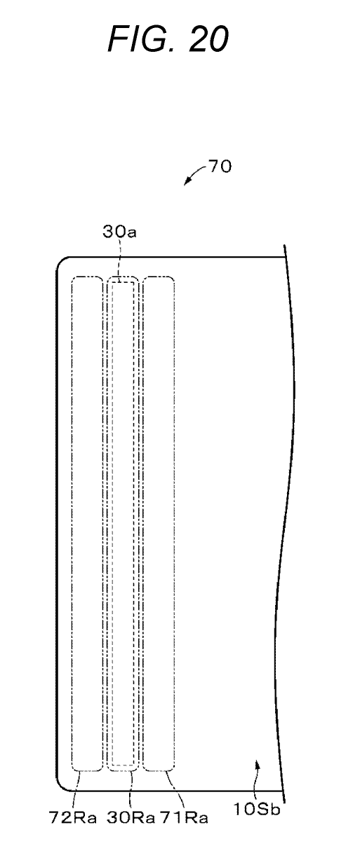

As illustrated in FIG. 20, in an electric apparatus 70 according to a third embodiment of the present technology differs from an electric apparatus 10 according to a first embodiment in that three sensing areas 30Ra, 71Ra, and 72Ra are provided on an end portion in a longitudinal direction of a back surface 10Sb having a rectangular shape.

A controller IC 12a detects which one of the three sensing areas 30Ra, 71Ra, and 72Ra pressing force is applied to, and executes operation in accordance with a detection result thereof. The sensing area 30Ra is an area provided substantially above sensor 30a. The sensing areas 71Ra and 72Ra are areas provided in a manner adjacent to both sides of the sensing area 30Ra. Functions of different electric apparatuses may be assigned to the sensing areas 30Ra, 71Ra, and 72Ra respectively, or operation relative to a menu screen or the like may be performed by using the sensing areas 30Ra, 71Ra, and 72Ra.

### 3.2 Pressing Force Detecting Operation

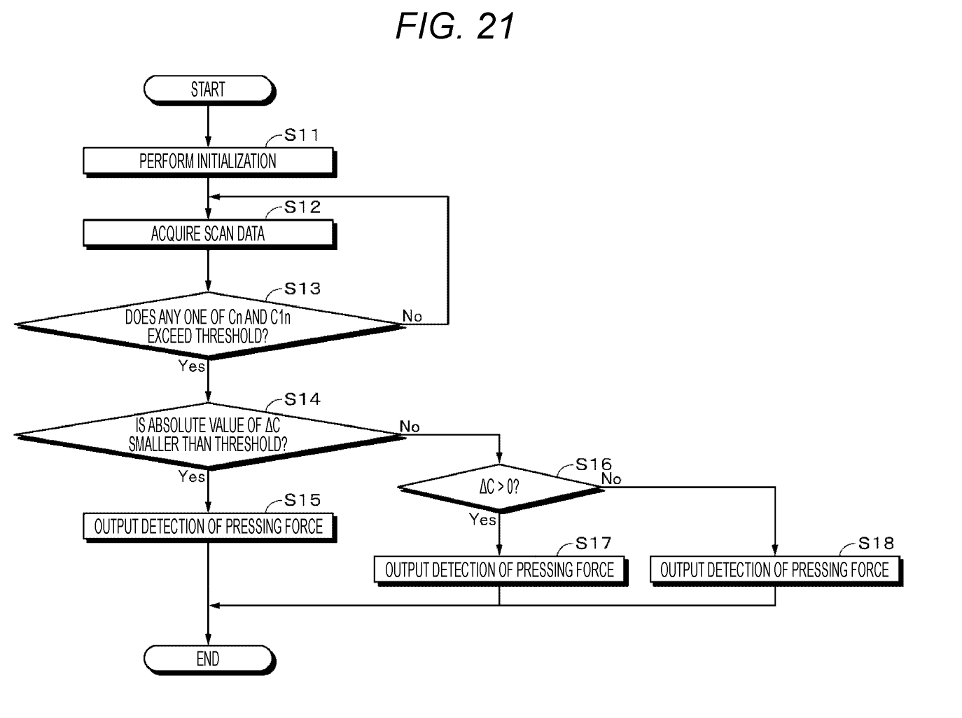

In the following, exemplary pressing force detecting operation in the controller IC 12a will be described with reference to FIG. 21. Note that processing from step S11 to step S15 is similar to that in the first embodiment, and therefore, a description therefor will be omitted.

In a case where the controller IC 12a determines that an absolute value |ΔC| of a difference between capacitance changes is not smaller than a threshold in step S14, the controller IC 12a determines in step S16 whether the difference ΔC between the capacitance changes satisfies ΔC>0, specifically, whether the difference is a positive value.

In a case where the controller IC 12a determines in step S16 that ΔC>0 is satisfied, the controller IC 12a notifies, in step S17, a host 11 of a fact that pressing force applied to the sensing area 71Ra is detected. On the other hand, in a case where the controller IC 12a determines in step S16 that ΔC>0 is not satisfied, the controller IC 12a notifies, in step S18, the host 11 of a fact that pressing force applied to the sensing area 72Ra is detected.

### 3.3 Effects

In the third embodiment, it is possible to detect, by using one sensor 30a, pressing force applied to the sensing area 30Ra set above the sensor 30a and pressing force applied the sensing areas 71Ra and 72Ra respectively provided on both sides of the sensing area 30Ra. Therefore, the configuration of the electric apparatus 70 can be more simplified compared to a case where the sensor 30a is provided in each of the sensing areas 30Ra, 71Ra, and 72Ra. Additionally, a cost for the electric apparatus 70 can be reduced.

### 3.4 Modified Example

The electric apparatus 70 according to the third embodiment of the present technology includes a sensor 60a of a second embodiment instead of the sensor 30a.

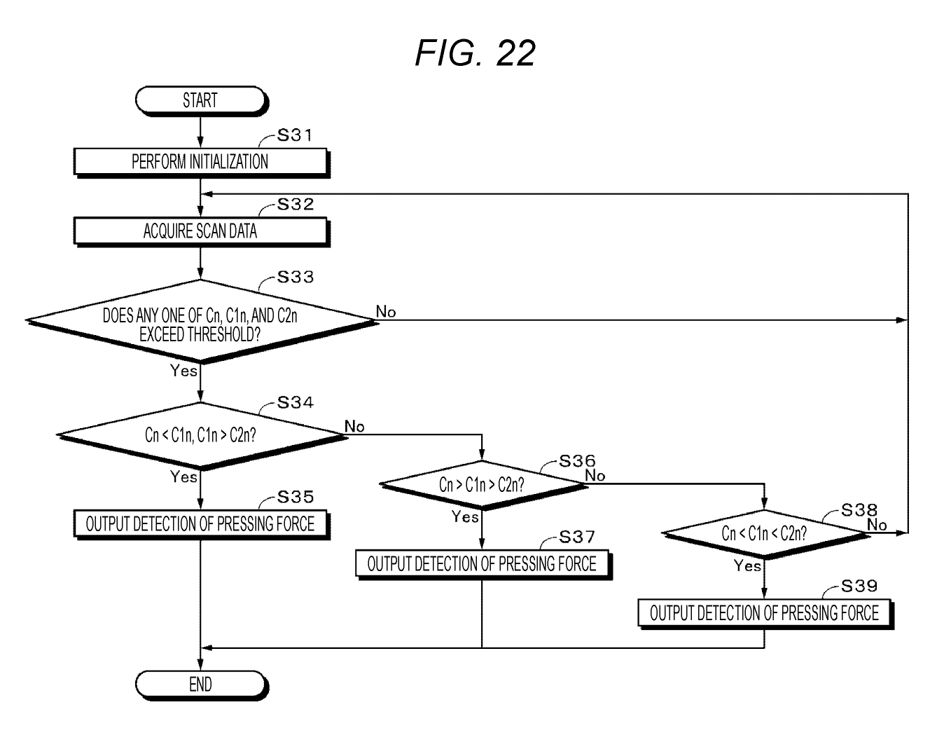

In the following, exemplary pressing force detecting operation in the controller IC 12a will be described with reference to FIG. 22. Note that processing from step S31 to step S35 is similar to that in the second embodiment, and therefore, a description therefor will be omitted.

In a case where that the controller IC 12a determines in step S34 that relations of Cn<C1n and C1n>C2n are not satisfied, the controller IC 12a determines in step S36 whether a relation of Cn>C1n>C2n is satisfied.

In a case where the controller IC 12a determines in step S36 that the relation Cn>C1n>C2n is satisfied, the controller IC 12a notifies the host 11 of a fact that pressing force applied to the sensing area 71Ra is detected in step S37. On the other hand, in a case where the controller IC 12a determines in step S36 that the relation Cn>C1n>C2n is not satisfied, the controller IC 12a determines in step S38 whether a relation of Cn<C1n<C2n is satisfied.

In a case where the controller IC 12a determines in step S38 that the relation of Cn<C1n<C2n is satisfied, the controller IC 12a notifies the host 11 of a fact that pressing force applied to the sensing area 72Ra is detected in step S39. On the other hand, in a case where the controller IC 12a determines in step S38 that the relation of Cn<C1n<C2n is not satisfied, the processing returns to step S32.

The controller IC 12a may notify the host 11 of only detection in one or two areas of the above-described sensing areas 30Ra, 71Ra, and 72Ra. In this case, the electric apparatus 70 can be made deemed to have only one or two areas out of the above-described sensing areas 30Ra, 71Ra, and 72Ra.

While the embodiments and modified examples thereof in the present technology have been specifically described, the present technology is not limited to the above-described embodiments, and modified examples thereof, and various kinds of modification based on the technical idea of the present technology can be made.

For example, the configurations, methods, processes, shapes, materials, numerical values, and the like described in the above-described embodiments and modified examples thereof are merely examples, and a configuration, a method, a process, a shape, a material, and a numerical value different from these may be used as needed.

Also, the configurations, methods, processes, shapes, materials, numerical values, and the like in the above-described embodiments and modified examples can be combined each other without departing from the gist of the present technology.

Additionally, the present technology can adopt configurations below.

(1)

An input device including:

a housing; and

a capacitive sensor provided in the housing,

in which the sensor includes:

a flexible conductive layer;

two rows of sensing units provided in a manner facing the conductive layer; and

a structural body which is provided between the two rows when viewed from a thickness direction of the sensor, and separates the conductive layer from the two rows of the sensing units.

(2)

The input device recited in to (1), further including a fixing member adapted to press the sensor against the housing.

(3)

The input device recited in (1) or (2), further including:

a support layer provided between the sensor and the fixing member; and

an elastic layer provided between the fixing member and the support layer.

(4)

The input device recited in any one of (1) to (3), further including a first projecting portion and a second projecting portion provided on the conductive layer,

in which the first projecting portion and the second projecting portion are respectively provided at positions overlapping with the two rows when viewed from the thickness direction of the sensor.

(5)

The input device recited in any one of (1) to (4), in which the structural body extends between the two rows.

(6)

The input device recited in any one of (1) to (5), in which a portion between the row and the conductive layer is an empty space.

(7)

The input device recited in (6), in which the empty space is divided by the structural body.

(8)

The input device recited in any one of (1) to (7), further including a row of sensing units, the row facing the conductive layer and being provided between the two rows of the sensing units.

(9)

The input device recited in any one of (1) to (8), in which side portions of a structural layer including the structural body are open.

(10)

The input device recited in any one of (1) to (9), in which the sensing unit includes: an electrode line extending in a row direction of the sensing units; and an electrode body provided in a manner overlapping with the electrode line in the thickness direction of the sensor, and including a linear electrode element.

(11)

The input device recited in any one of (1) to (10), in which

the sensor is a long sheet, and

the row of the sensing units extends in a longitudinal direction of the sensor.

(12)

The input device recited in any one of (1) to (11), in which the housing is bendable.

(13)

The input device recited in any one of (1) to (12), in which the housing has a recessed portion to house the sensor.

(14)

The input device recited in any one of (1) to (13), further including a control unit adapted to detect pressing force applied to the housing on the basis of a capacitance change in the sensing unit.

(15)

A capacitive sensor including:

a flexible conductive layer;

two rows of sensing units provided in a manner facing the conductive layer; and

a structural body which is provided between the two rows when viewed from a thickness direction of the sensor, and separates the conductive layer from the two rows of sensing units.

(16)

An electric apparatus including the input device recited in any one of (1) to (14).

(17)

A detection method including:

determining whether a capacitance change output from each of sensing units forming a plurality of rows exceeds a threshold; and

in a case where the capacitance change exceeds the threshold, determining which one of a region above the sensor and outside of the region is applied with pressing force on the basis of the capacitance change.

(18)

The detection method recited in (17), in which determination on pressing force is performed by comparing the capacitance changes between the plurality of rows.

(19)

The detection method recited in (17), in which determination on pressing force is performed by comparing capacitance changes in the sensing units adjacent in a direction between the rows.

(20)

The detection method recited in (17), in which determination on pressing force is performed on the basis of whether a difference in the capacitance changes between the rows exceeds a threshold.

### REFERENCE SIGNS LIST

10 Electric Apparatus
10Sa Front surface
10Sb Back surface
11 Host
11PL Display device
11CM Camera module
12a, 12 Controller IC
13a, 13b PCBA
14a, 14b FPC
20 Housing
21 First housing
22 Second housing
23a, 23b Recessed portion
30Ra, 30Rb Sensing area
30a, 30b Sensor
ND Node (sensing unit)
30TP Projecting portion (first and second projecting portions)
31b, 34b Conductive layer
33a Structural body
33d Empty space portion (empty space)
32EXa Electrode body
32EYa Electrode line
41 Fixation plate (fixing member)
43 Support plate (support layer)
44 Elastic layer

1. An input device comprising:
a housing; and
a capacitive sensor provided in the housing,
wherein the sensor including:
a flexible conductive layer;
two rows of sensing units provided in a manner facing the conductive layer; and
a structural body which is provided between the two rows when viewed from a thickness direction of the sensor, and separates the conductive layer from the two rows of the sensing units.

2. The input device according to claim 1, further comprising a fixing member configured to press the sensor against the housing.

3. The input device according to claim 1, further comprising:
a support layer provided between the sensor and the fixing member; and
an elastic layer provided between the fixing member and the support layer.

4. The input device according to claim 1, further comprising a first projecting portion and a second projecting portion provided on the conductive layer,
wherein the first projecting portion and the second projecting portion are respectively provided at positions overlapping with the two rows when viewed from the thickness direction of the sensor.

5. The input device according to claim 1, wherein the structural body extends between the two rows.

6. The input device according to claim 1, wherein a portion between the row and the conductive layer is an empty space.

7. The input device according to claim 6, wherein the empty space is divided by the structural body.

8. The input device according to claim 1, further comprising a row of sensing units, the row facing the conductive layer and being provided between the two rows of the sensing units.

9. The input device according to claim 1, wherein side portions of a structural layer including the structural body are open.

10. The input device according to claim 1, wherein the sensing unit includes: an electrode line extending in a row direction of the sensing units; and an electrode body provided in a manner overlapping with the electrode line in the thickness direction of the sensor, and including a linear electrode element.

11. The input device according to claim 1, wherein
the sensor is a long sheet, and
the row of the sensing units extends in a longitudinal direction of the sensor.

12. The input device according to claim 1, wherein the housing is bendable.

13. The input device according to claim 1, wherein the housing has a recessed portion to house the sensor.

14. The input device according to claim 1, further comprising a control unit configured to detect pressing force applied to the housing on the basis of a capacitance change in the sensing unit.

15. A capacitive sensor comprising:
a flexible conductive layer;
two rows of sensing units provided in a manner facing the conductive layer; and
a structural body which is provided between the two rows when viewed from a thickness direction of the sensor, and separates the conductive layer from the two rows of sensing units.

16. An electric apparatus comprising:
a housing; and
a capacitive sensor provided in the housing,
wherein the sensor includes:
a flexible conductive layer;
two rows of sensing units provided in a manner facing the conductive layer; and
a structural body which is provided between the two rows when viewed from a thickness direction of the sensor, and separates the conductive layer from the two rows of the sensing units.

17. A detection method comprising:
determining whether a capacitance change output from each of sensing units forming a plurality of rows exceeds a threshold; and
in a case where the capacitance change exceeds the threshold, determining which one of a region above the sensor and outside of the region is applied with pressing force on the basis of the capacitance change.

18. The detection method according to claim 17, wherein determination on pressing force is performed by comparing the capacitance changes between the plurality of rows.

19. The detection method according to claim 17, wherein determination on pressing force is performed by comparing capacitance changes in the sensing units adjacent in a direction between rows.

20. The detection method according to claim 17, wherein determination on pressing force is performed on the basis of whether a difference in the capacitance changes between the rows exceeds a threshold.
